(19) United States
(12) Patent Application Publication
(10) Pub. No.: US 2018/0271283 A1
(43) Pub. Date: Sep. 27, 2018

(54) OVERTURN PREVENTING DEVICE

(71) Applicant: KYB CORPORATION, Minato-ku, Tokyo (JP)

(72) Inventors: Yukiko ISHIHARA, Minato-ku, Tokyo (JP); Akihisa OTA, Minato-ku, Tokyo (JP); Chika IIDA, Minato-ku, Tokyo (JP); Masaya UNE, Minato-ku, Tokyo (JP)

(73) Assignee: KYB CORPORATION, Minato-ku, Tokyo (JP)

(21) Appl. No.: 15/755,702

(22) PCT Filed: Sep. 1, 2016
(86) PCT No.: PCT/JP2016/075593

§ 371 Date: Feb. 27, 2018

(30) Foreign Application Priority Data
Sep. 11, 2015 (JP) 2015-179296
Dec. 22, 2015 (JP) 2015-250075

(51) Int. Cl. A47B 97/00

(52) U.S. Cl. CPC A47B 97/00; F16F 9/061; A47B 2097/008

(57) ABSTRACT

Providing an overturn preventing device which can easily be mounted between a top surface of an article and a ceiling. The overturn preventing device includes a damper, a pair of bases and a fixing cord. The damper is mounted between a top surface of a piece of furniture installed on a floor and a ceiling. The bases are respectively coupled to both ends of the damper. The first base abuts against the top surface of the furniture, and the other base abuts against the ceiling. The fixing cord holds the damper in a contracted state in which the damper has a desired length.

### TECHNICAL FIELD

The present invention relates to an overturn preventing device.

### BACKGROUND ART

Patent Document 1 discloses a conventional overturn preventing device. This overturn preventing device includes a damper and a pair of bases. The damper is mounted between a top surface of a piece of furniture installed on a floor and a ceiling. The damper has two ends respectively supported by the paired bases to be rotatable about rotation axes. One of the bases abuts against the top surface of the furniture and the other s abuts against the ceiling. As a result, in this overturn preventing device, when the furniture is tilted by shaking of earthquake or the like in a direction parallel to a rotation direction of the damper, the damper is rotated about the rotation axes relative to the bases so that the bases can be maintained in abutment against the top surface of the furniture and the ceiling respectively. As a result, this overturn preventing device can apply a damping force of the damper to the furniture thereby to suppress the tilt of the furniture and prevent the furniture from overturn.

### PRIOR ART DOCUMENT

### Patent Documents

Patent Document 1: Japanese Patent Application Publication No. JP 2015-6330

### SUMMARY OF THE INVENTION

### Problem to be Overcome by the Invention

However, when the overturn preventing device of Patent. Document 1 is to be mounted between the top surface of the furniture and the ceiling, the paired bases are respectively required to abut against the top surface of the furniture and the ceiling so that the overturn preventing device takes a desired posture (for example, a posture in which the damper is set at a desired inclination angle) while the damper is contracted against an expansion force of compressed gas acting in an extension direction of the damper. Thus, there is a difficulty in the work of mounting overturn preventing device into the desired posture while the worker contracts the damper above the furniture.

The present invention was made in view of the above-described circumstances in the conventional art and has an object to provide an overturn preventing device which can easily be mounted between a top surface of an article and the ceiling.

### Means for Overcoming the Problem

An overturn preventing device of the present invention includes a damper, a pair of bases, and a fixing cord. The damp is mounted between a top surface of an article installed on an installation surface and a ceiling. The bases are respectively coupled to both ends of the damper. One of the bases abuts against the top surface of the article. The other base abuts against the ceiling. The fixing cord holds the damper in a contracted state in which the damper has a desired length.

In this overturn preventing device, one of the bases is placed in abutment on the top surface of the article while the damper is held in the contracted state with the desired length by the fixing cord. And after the damper has been positioned in the mounting state so that the damper extends in a desired direction, the fixing cord is loosened or cut. Thereupon, the damper is extended with the result that the other base abuts against the ceiling, whereby the mounting work can be completed. Thus, since the worker does not need to carry out the mounting work above the article while contracting the damper, the overturn preventing device can easily be mounted between the top surface of the article and the ceiling.

Accordingly, the overturn preventing device of the invention can easily be mounted between the top surface of the article and the ceiling.

Furthermore, if the degree of extension of the damper is rendered small when the damper changes from the state contracted by the fixing cord to the state where the other base abuts against the ceiling, shock caused by abutment of the other base against the ceiling can be rendered small. Therefore, according to a distance between the top surface of the article and the ceiling, a plurality of types of overturn preventing devices having different lengths of the cylinder and the rod of the damper preferably may be prepared, and furthermore, a plurality of types of overturn preventing devices having different contraction lengths of the damper preferably may be prepared by use of the fixing cord for the damper having the same lengths of the cylinders and the rods.

The bases of the overturn preventing device of the invention may respectively have rotating shaft members rotatably supporting both ends of the damper. And the fixing cord may be locked on the rotating shaft members. In this case, the damper can be held in the contracted state with a desired length by use of the rotating shaft members respectively located at both ends of the damper, without providing the structure only for locking the fixing cord.

In the overturn preventing device of the invention, each of the rotating shaft members may have two ends exposed from the base at respective positions symmetrical with respect to a central axis of the damper. The fixing cord may have two sides which are respectively locked on both ends of the rotating shaft members exposed from the bases and have a middle part extending as a single code. In this case, the damper can be held in the contracted state in a balanced manner since the fixing cord which is locked on both ends of the rotating shaft members at both ends thereof extends as a single cord in the middle part thereof.

The overturn preventing device of the invention may further include an angle regulator. The angle regulator is mounted on the base abutting against the top surface of the article and regulates an inclination angle of the damper. In this case, when the base is placed in abutment on the top surface of the article, the damper is disposed at a desired inclination angle by the angle regulator. And when the fixing cord is loosened or cut in this state, the overturn preventing device can be mounted between the top surface of the article and the ceiling with the damper being set at the desired inclination angle.

Here, the article includes furniture, a bed having a plurality of beds connected to each other in the up-down direction, large sized televisions, refrigerators, book shelves, showcases, server racks, and the like all of which have a possibility of being overturned by shaking of earthquake or the like.

The fixing cord of the overturn preventing device of the invention may include a grip coupled to the base abutting against the ceiling, and an article-side coupling part coupling the base abutting against the top surface of the article and the grip. In the case of mounting this overturn preventing device, the overturn preventing device is placed on the top surface of the article when being set in the contracted state by the fixing cord, and then the article-side coupling part is loosened or cut, whereby the overturn preventing device can easily be mounted between the ceiling and the article. And in the mounted state, the grip coupled to the base abutting against the ceiling is disposed so as to droop from the base. The worker can separate the base from the ceiling against the biasing force of the damper by pulling the grip downward. Thus, since an operation to separate the base from the ceiling is rendered easier to carry out even after the base has abutted against the ceiling, the base can easily be relocated.

In the overturn preventing device of the invention, the grip may include at least a part thereof formed into a shape indicative of a predetermined direction representing a location side of the base abutting against the ceiling or the base abutting against the top surface of the article. When at least the part of the grip is thus formed into the shape indicative of the predetermined direction, the worker can understand the mounting direction of the fixing cord more easily. For example, an error that the fixing cord is mounted upside down on both bases can be reduced. Furthermore, when the bases to which the fixing cord has been attached are respectively mounted on the article and the ceiling, the worker can confirm the base to be mounted on the ceiling side or the base to be mounted on the article side on the basis of the shape indicative of the direction represented by the grip. This can reduce an error that the article-side and ceiling-side bases are mounted in reverse.

The fixing cord of the overturn preventing device of the invention may further include a ceiling-side coupling part coupling the base abutting against the ceiling and the grip. And the ceiling-side coupling part may be thicker than the article-side coupling part. When the ceiling-side coupling part is thicker than the article-side coupling part, the strength of the ceiling-side coupling part can be enhanced and the cutting or the like of the article-side coupling part can be performed easily. When the strength of the ceiling-side coupling part is enhanced, breakage or the like is less likely to occur even if a great force is applied between the grip and the base when the grip is pulled downward to be separated from the ceiling after the base has been mounted on the ceiling.

The fixing cord of the overturn preventing device of the invention may include a fixed part attached to the base abutting against the ceiling and a first mark formed at a position away from the fixed part. And the first mark may be indicative of a location of a predetermined part of the damper when the damper has a predetermined maximum length in a state where a part of the fixing cord at least from the fixing part to the first mark droops from the base abutting against the ceiling. According to the construction, the positional relationship between the first mark and a predetermined part of the damper can easily be confirmed after both bases are respectively mounted on the article side and the ceiling side by the release of the fixing code. As a result, it can easily be confirmed whether or not the length of the damper in the mounted state is below a predetermined maximum length. For example, when the first mark formed in the fixing cord drooping from the base abutting against the ceiling is located above a predetermined part of the damper, it can be understood that the length of the damper exceeds the predetermined maximum length. In an opposite manner, when the first mark formed in the fixing cord drooping from the base abutting against the ceiling is located below the predetermined part of the damper, it can be confirmed that the length of the damper is below the predetermined maximum length.

The fixing cord of the overturn preventing device of the invention may further include a second mark formed at a location other than that of the first mark. The second mark may be indicative of a location of the predetermined part of the damper when the damper has a predetermined minimum length in a state where a part of the fixing cord at least from the fixing part to the second mark droops from the base abutting against the ceiling. According to the construction, after both bases are respectively mounted on the article side and the ceiling side by the release of the fixing code, it can easily be confirmed whether or not the length of the damper is not less than a predetermined minimum length by confirming the positional relationship between the second mark and a predetermined part of the damper. For example, when the second mark formed on the fixing cord drooping from the base abutting against the ceiling is located above the predetermined part of the damper after the mounting of both bases, it can be confirmed that the length of the damper is not less than the predetermined minimum length. In an opposite manner, when the second mark formed on the fixing cord drooping from the base abutting against the ceiling is located below the predetermined part of the damper, it can be understood that the length of the damper does not reach the predetermined minimum length.

In the fixing cord of the overturn preventing device of the invention, the location of the first mark may be a cutting location. According to the construction, the cutting location can clearly be presented to the worker carrying out the mounting work. And, in the mounted state after the cutting, it can be confirmed whether or not the length of the damper is below a predetermined maximum length by confirming the positional relationship between the lower end of the fixing cord drooping from the base abutting against the ceiling and the predetermined part of the damper. As a result, the confirming work becomes more accurate and easier.

The fixing cord of the overturn preventing device may have through hole parts respectively formed at a location near one of the bases and at a location near the other base. In the case of mounting this overturn preventing device, the overturn preventing device is placed on the top surface of the article when being set in the contracted state by the fixing cord, and then the fixing code between the hole parts is loosened or cut, whereby the overturn preventing device can easily be mounted between the ceiling and the article. When the damper needs to be held in the contracted state again after the damper has been released from the contracted state by the fixing cord thereby to be caused to extend, the damper can be maintained in the contracted state again by connecting both hole parts using a wire, string or another connecting member.

### BRIEF DESCRIPTION OF THE DRAWINGS

FIG. 1 is a side view of the overturn preventing device ref a first embodiment, mounted between a top surface of furniture and the ceiling;

FIG. 2 is a front view of the overturn preventing device of the first embodiment, mounted between the top surface of the furniture and the ceiling;

FIG. 3 is a partial cross section of a damper and a first base of the overturn preventing device of the first embodiment;

FIG. 4 is a perspective view of the damper, the first base, and a fall preventing part of the overturn preventing device of the first embodiment;

FIG. 5 is a partial cross section of the damper, the first base, and the fall preventing part of the first embodiment;

FIG. 6 is a partial cross section of the damper, the first base, and an angle regulator of the overturn preventing device of the first embodiment;

FIG. 7 is a rear view of the overturn preventing device of the first embodiment, maintained in a contracted state by a fixing cord;

FIG. 8 is a side view illustrating an intermediate step of mounting the overturn preventing device of the first embodiment between the top surface of the furniture and the ceiling;

FIG. 9 is a side view of the overturn preventing device of the first embodiment, illustrating a state where the fall preventing part is caught on a wall surface;

FIG. 10 is a schematic perspective view of the overturn preventing device of a second embodiment, illustrating an intermediate step of mounting the overturn preventing device between the top surface of the furniture and the ceiling;

FIG. 11 is a plan view of a band member forming a grip of the overturn preventing device of the second embodiment;

FIG. 12 is a schematic perspective view of the overturn preventing device of the second embodiment, mounted between the top surface of the furniture and the ceiling;

FIG. 13 is a side view of the overturn preventing device of the second embodiment, mounted between the top surface of the furniture and the ceiling;

FIG. 14 is a side view illustrating an intermediate step of mounting the overturn preventing device of a third embodiment between the top surface of the furniture and the ceiling;

FIG. 15 is a perspective view of a fixing cord of the overturn preventing device of the third embodiment;

FIG. 16 is a side view of the overturn preventing device of the third embodiment, mounted between the top surface of the furniture and the ceiling;

FIG. 17 is a schematic partial cross section illustrating the structure of the vicinity of the grip and the second base of the overturn preventing device of the third embodiment, mounted between the top surface of the furniture and the ceiling;

FIG. 18 is a schematic partial cross section illustrating the structure of the vicinity of the grip and the first base of the overturn preventing device of the third embodiment, mounted between the top surface of the furniture and the ceiling;

FIG. 19 is a schematic perspective view of the overturn preventing device of a fourth embodiment, illustrating an intermediate step of mounting the overturn preventing device between the top surface of the furniture and the ceiling;

FIG. 20 is a perspective view of the fixing cord of the overturn preventing device of the fourth embodiment;

FIG. 21 is a side view of the overturn preventing device of the fourth embodiment, mounted between the top surface of the furniture and the ceiling;

FIG. 22 is a schematic partial cross section illustrating the structure of the vicinity of the grip and the second base of the overturn preventing device of the fourth embodiment, mounted between the top surface of the furniture and the ceiling;

FIG. 23 is an illustration schematically explaining an inner structure of the damper;

FIG. 24 is a side view illustrating an intermediate step of mounting the overturn preventing device of a fifth embodiment between the top surface of the furniture and the ceiling;

FIG. 25 is a perspective view of the fixing cord of the overturn preventing device of the fifth embodiment;

FIG. 26 is a side view of the overturn preventing device of the fifth embodiment, mounted between the top surface of the furniture and the ceiling;

FIG. 27 is a side view illustrating an intermediate step of mounting the overturn preventing device of a sixth embodiment between the top surface of the furniture and the ceiling;

FIG. 28 is a perspective view of the fixing cord of the overturn preventing device of the sixth embodiment;

FIG. 29 is a side view of the overturn preventing device of the sixth embodiment, mounted between the top surface of the furniture and the ceiling;

FIG. 30 is a schematic partial cross section illustrating the structure of the vicinity of the grip and the second base of the overturn preventing device of the sixth embodiment, mounted between the top surface of the furniture and the ceiling;

FIG. 31 is a side view of the overturn preventing device of a seventh embodiment, mounted between the top surface of the furniture and the ceiling; and

FIG. 32 is a perspective view of the fixing cord of the overturn preventing device of the seventh embodiment.

### BEST MODE FOR CARRYING OUT THE INVENTION

A first embodiment of the overturn preventing device of the present invention will be described with reference to the drawings.

### First Embodiment

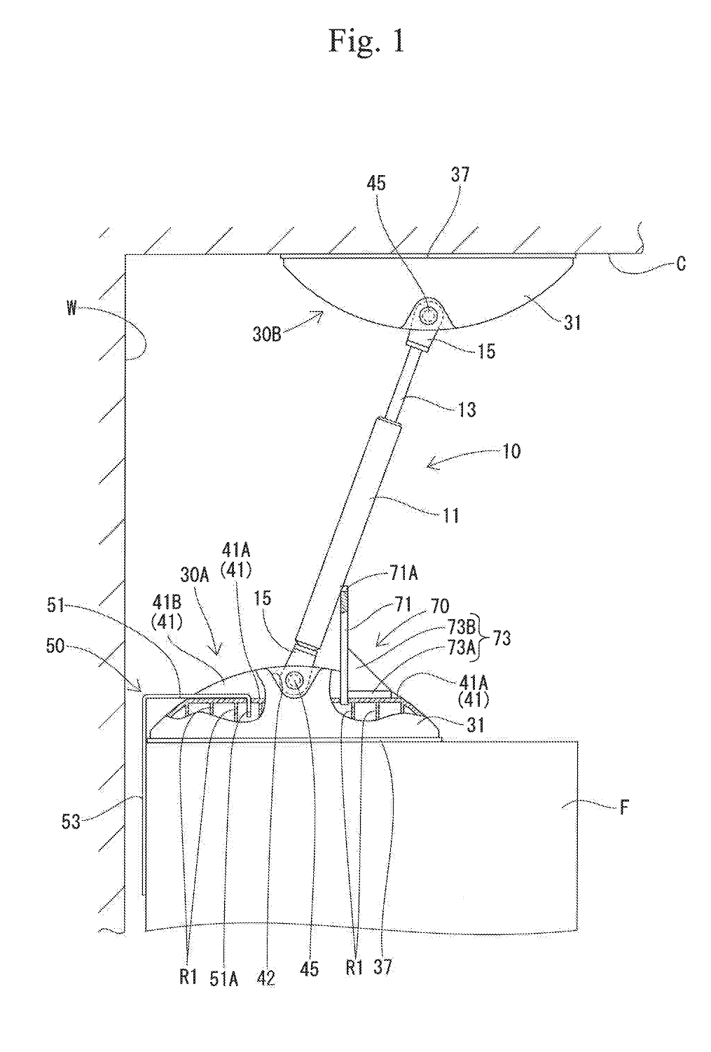

At least one overturn preventing device of the first embodiment is mounted between a top surface of a piece of furniture F and a ceiling C, as illustrated in FIG. 1. The furniture F is installed on a floor surface (not illustrated) while a rear surface of the furniture F is opposed to a wall surface W extending in a vertical direction from the floor surface. The furniture F is formed into a rectangular parallelepiped shape and has a door, drawers (neither illustrated) and the like in a front surface (a right side as viewed in FIG. 1), so that clothes, accessories and the like can be housed in the furniture F. The furniture F has a rectangle-shaped horizontal section long in a right-left direction (a depthwise direction in FIG. 1). When the overturn preventing device is not mounted on the furniture F, the furniture F would possibly be tilted frontward (rightward in FIG. 1) by shaking of earthquake or the like thereby to be overturned.

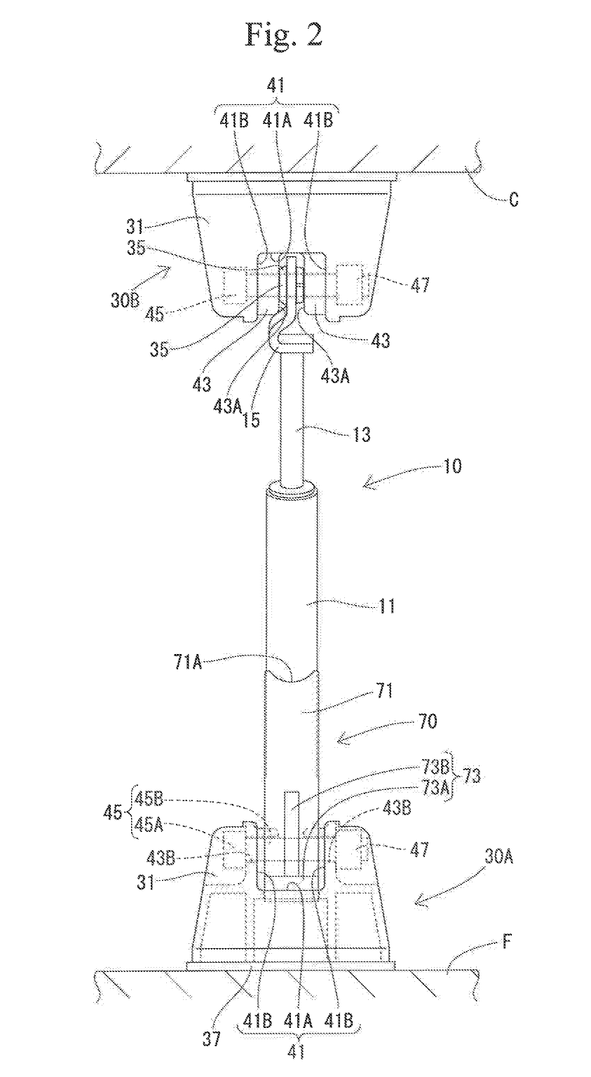

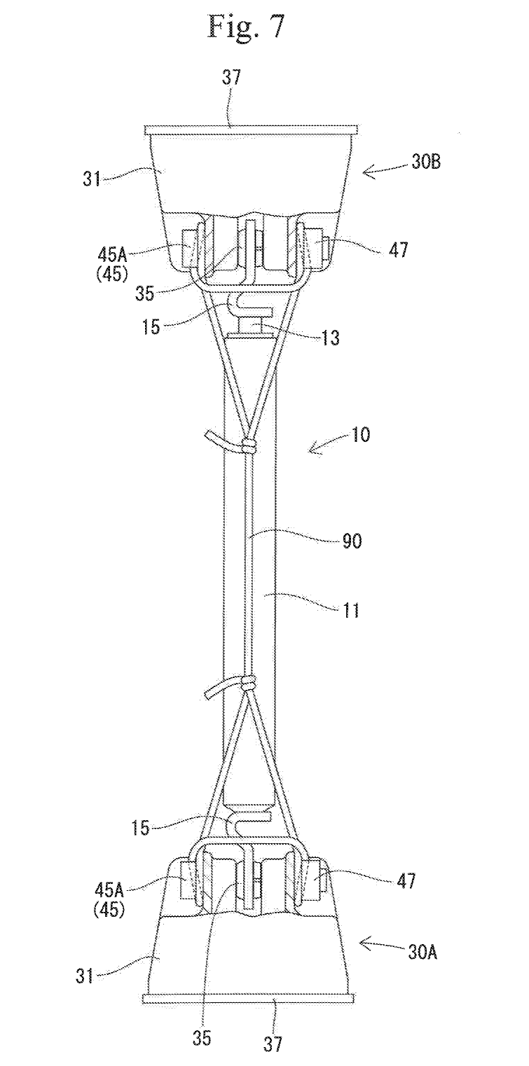

The overturn preventing device includes a damper 10, a pair of bases 30A and 30E, a fall preventing part 50, and an angle regulator 70, as illustrated in FIGS. 1 and 2. The overturn preventing device further includes a fixing cord 90 as illustrated in FIG. 7.

The damper 10 has a cylinder 11, a rod guide (not illustrated), a piston (not illustrated), a rod 13, and two joints 15 respectively provided on both ends of the damper 10. The cylinder 11 is bottomed and has a cylindrical shape. The rod guide closes an opening of the cylinder 11. The piston is slidably inserted in the cylinder 11. The rod 13 has a proximal end connected to the piston. The rod 13 is inserted through the rod guide, so that a distal end thereof protrudes out of the cylinder 11. The cylinder 11 is filled with a hydraulic fluid and a compressed gas. Each joint 15 is formed by bending a flat plate-shaped metal fitting as illustrated in FIGS. 1 to 3. The joints 15 are respectively connected to a bottom of the cylinder 10 and the distal end of the rod 13. Each joint 15 is formed with a through hole 15A extending therethrough in a direction perpendicular to an axis line of the damper 10.

The damper 10 is a compression damper in which a damping force generated during an extending operation is smaller than a damping force generated during a contracting operation. The extending operation of the damper 10 refers to an operation which increases an amount of protrusion of the rod 13 out of the cylinder 11 and the length of the damper 10. The contracting operation of the damper 10 refers to an operation which reduces an amount of protrusion of the rod 13 out of the cylinder 11 and the length of the damper 10. An expansion force of the compressed gas enclosed in the cylinder 11 works in an extension direction of the damper 10.

The following will describe a mechanism of generating a damping force by the damper 10. Since the mechanism has a known structure, diagrammatic representation is eliminated. The cylinder 11 has an interior divided by the piston into a rod side pressure chamber in which the proximal end of the rod 13 is housed and a counter-rod side pressure chamber. The piston is formed with an orifice which is a throttle valve communicating between both pressure chambers. The orifice functions as a damping force generator which applies resistance to a flow of the hydraulic fluid between the rod side pressure chamber and the counter-rod side pressure chamber with the extending/contracting operation of the damper 10. Furthermore, the piston is formed with communication path communicating with both pressure chambers via a check valve. The check valve allows the hydraulic fluid to flow from the rod side pressure chamber to the counter-rod side pressure chamber and blocks reverse flow of the hydraulic fluid. Accordingly, the damper 10 has two flow paths of the hydraulic fluid from the rod side pressure chamber to the counter-rod side pressure chamber during the extending operation, that is, one flow path including the orifice and the other flow path including the communication path. On the other hand, the damper 10 has only one flow path of the hydraulic fluid from the counter-rod side pressure chamber to the rod side pressure chamber through the orifice during the contracting operation. Accordingly, the damping force generated by the damper 10 during the extending operation is smaller than the damping force generated by the damper 10 during the contracting operation.

The paired bases 30A and 30E are respectively a first base 30A to which the joint 15 connected to the bottom of the cylinder 11 is coupled and a second base 30B to which the joint 15 connected to a distal end of the rod 13 is coupled, as illustrated in FIGS. 1 and 2. The first base 30A is placed in abutment on the top surface of the furniture F, and the second base 30B abuts against the ceiling. The first and second bases 30A and 30B have the same form and the same structure. Each of the bases 30A and 30B has a base body 31, a bolt 45 and a nut 47 serving as a rotating shaft member, a bush 35, and a slip preventing part 37, as illustrated in FIGS. 1 to 4.

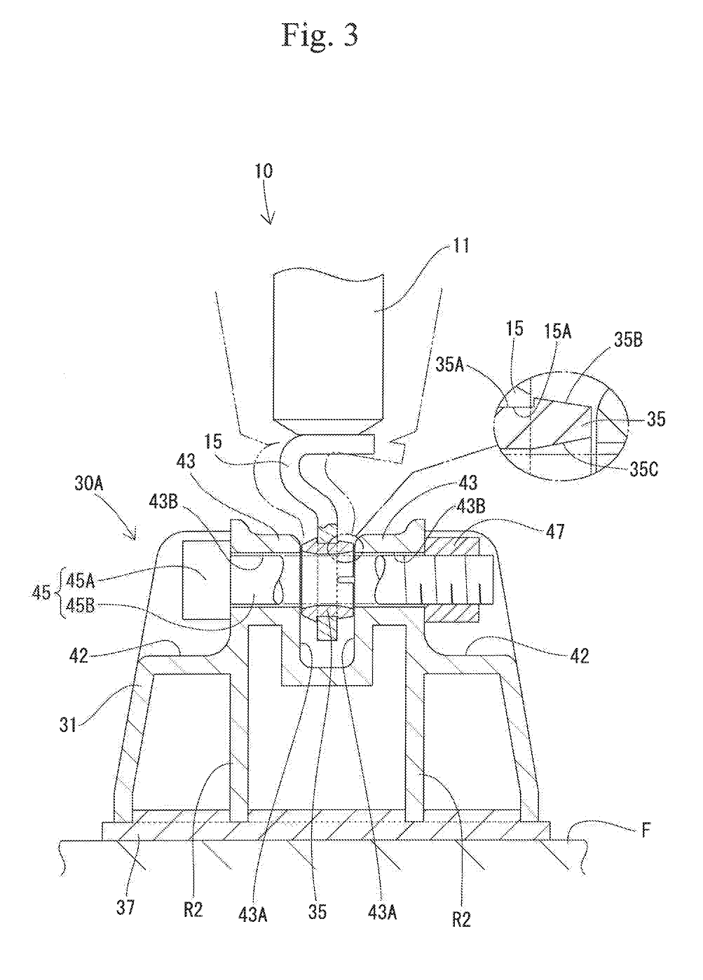

The base body 31 has a rectangular outer shape in a planar view as viewed from above in a state where the first base 30A is placed in abutment on the top surface of the furniture F (hereinafter, a direction in which a long side in the outer shape of the base body 31 extends in this planar view will be referred to as “a long side direction” and a direction in which a short side extends will be referred to as “a short side direction”). Furthermore, in a side view of the first base 30A as viewed in the short side direction in the state where the first base 30A is placed in abutment on the top surface of the furniture F, the base body 31 has a lower edge which extends straightforward in parallel to the top surface of the furniture F and an upper edge which upwardly bulges from both sides of the lower edge thereby to have an arc-shaped outer shape (refer to FIG. 1). Still furthermore, in a side view of the first base 30A as viewed in the long side direction in the state where the first base 30A is placed in abutment on the top surface of the furniture F, the base body 31 has a trapezoidal outer shape in which the upper edge is shorter than the lower edge (refer to FIGS. 2 and 3).

In the first base 30A placed in abutment on the top surface of the furniture F, the base body 31 has a groove 41 which is formed in an upper surface thereof and extends in the long side direction (a right-left direction as viewed in FIG. 1 and a depthwise direction as viewed in FIGS. 2 and 3). The groove 41 has a bottom 41A spreading on a horizontal surface and inner wall surfaces 41B respectively rising from both sides of the bottom 41A substantially in a vertical direction. The bottom 41A of the groove 41 extends substantially at a middle of the base body 31 in the up-down direction. Furthermore, the bottom 41A of the groove 41 has a constant width except for a portion formed with a pair of convex portions 43 which will be described later.

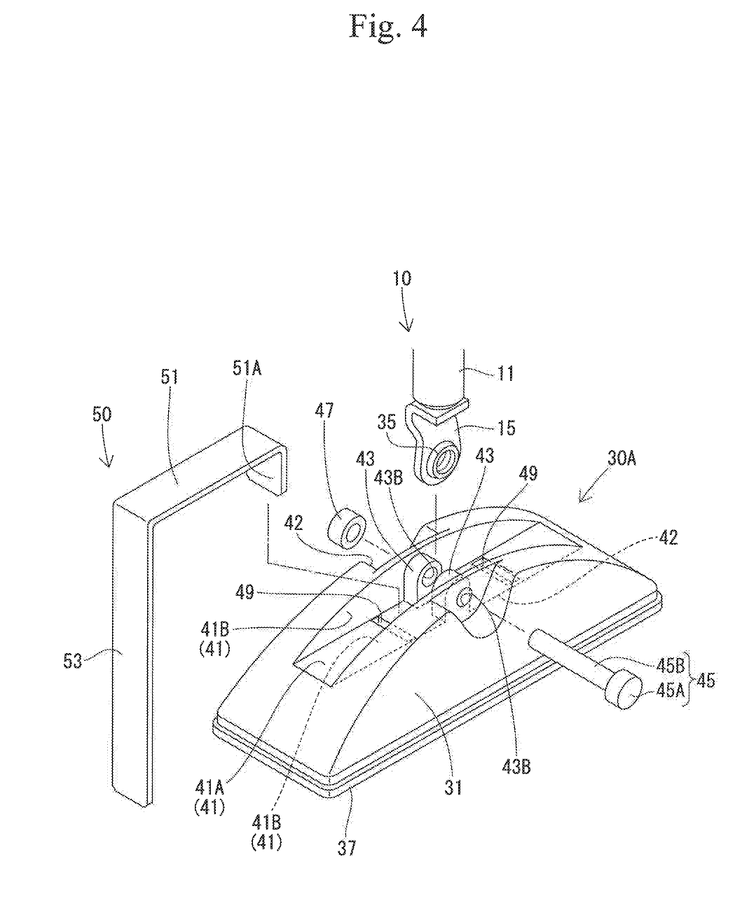

The groove 41 has the paired convex portions 43 which are formed at a central part thereof in the long side direction to protrude from the bottom 41A and both inner wall surfaces 41B of the groove 41, as illustrated in FIG. 4. A space is defined between the convex portions 43 as illustrated in FIGS. 2 and 3. The joint 15 of the damper 10 and a bush 35 which will be described later are fitted into the space. The space communicates with the groove 41. A distance (a dimension of the space in the short side direction) between the inner wall surfaces 43A of the convex portions 43 is slightly longer than a length of the bush 35. Furthermore, the convex portions 43 respectively have insertion holes 43B which are formed to extend through upper central parts thereof in the short side direction and through which a shaft part 45B of the bolt 45, which will be described later, is inserted.

A pair of locked holes 49 is formed in the bottom 41A of the groove 41 as illustrated in FIG. 4. The locked holes 49 are formed so that respective distances from the convex portions 43 toward both ends of the groove 41 are substantially equal to each other. Each locked hole 49 has the shape of a slit extending over an entire width of the groove 41. In other words, each locked hole 49 has a length equal to the width of the groove 41 and a width that is slightly larger than a thickness of a locking part 51A of the fall preventing part 50 and a thickness of an insertion part 71E provided in the angle regulator 70 which will be described later. One of the locked holes 49 serves as a locked part into which the locking part 51A of the fall preventing part 50 is inserted thereby to be locked. The other locked hole 49 serves as a locked part into which the insertion part 71B provided in the angle regulator 70 is inserted thereby to be locked.

In the first base 30A placed in abutment on the top surface of the furniture F, the base body 31 has recesses 42 respectively formed in both sides of the groove 41 in the middle in the long side direction. The recesses 42 are each open upward and outward with respect to the short side direction. The recesses 42 each have a side in which the insertion hole 43B formed through the convex portion 43 is open. A head 45A of the bolt 45 and the nut 47 screwed onto the bolt 45 which will be described later are respectively disposed in the recesses 42. The recesses 42 are formed to be upwardly spread in the long side direction so that tools can be fitted with the bolt head 45A and the nut 47 from above.

The base body 31 is hollow as illustrated in FIGS. 1 to 3. Furthermore, the base body 31 is downwardly open in the first base 30A placed in abutment on the top surface of the furniture F. The base body 31 has a plurality ribs R1 extending in parallel to the short side direction in the inside thereof and two ribs R2 extending in parallel to the long side direction in the inside thereof so that the ribs R1 and the ribs R2 intersect with each other.

The rotating shaft member includes the bolt 45 inserted from one of the insertion holes 43B of the base body 31 and the nut 47 screwed onto the shaft part 45B of the bolt 45, as illustrated in FIGS. 2 and 3. Central axes of the respective bolts 45 serve as rotation axes of the damper 10 in the bases 30A and 30B.

The bush 35 is substantially cylindrical in shape as illustrated in FIG. 3. The bush 35 is an elastic body. The bush 35 has a length that is slightly smaller than a distance between the inner wall surfaces 43A of the paired convex portions 43 provided in the base body 31. The bush 35 is formed with a concave portion 35A going around a central part of the outer peripheral surface thereof The concave portion 35A has an outer diameter that substantially equals an inner diameter of the through hole 15A formed through the joint 15 of the damper 10. The bush 35 has portions rising from both ends of the concave portion 35A which portions have outer diameters larger than the inner diameter of the through hole 15A of the joint 15. Furthermore, both ends of the bush 35 have respective outer peripheral surfaces 35B the diameters of which are outwardly reduced. As a result, the bush 35 is inserted into the through hole 15A of the joint 15 of the damper 10 while being elastically deformed. The concave portion 35A is then fitted into the through hole 15A so that the bush 35 is attached to the joint 15 of the damper 10.

The central part of the bush 35 has an inner diameter slightly larger than an outer diameter of the shaft part 45B of the bolt 45. Both ends of the bush 35 have inner peripheral surfaces 35C the diameters of which are outwardly enlarged. Accordingly, the bush 35 is rotatable about the shaft part 45B of the bolt 45. Furthermore, the bush 35 is inclinable with respect to the shaft part 45B of the bolt 45 to the extent that the inner peripheral surfaces 35C of both ends thereof having enlarged diameters abut against an outer peripheral surface of the shaft part 45B of the bolt 45. In other words, the damper 10 with the bush 35 attached to the joint 15 is rotatable about the shaft part 45B of the bolt 45 and swingable in a direction intersecting the rotation direction. More specifically, the damper is swung due to the dimensional allowance and the enlarged diameters of the inner peripheral surfaces 35C. Furthermore, by the elastic deformation of the bush 35, the damper 10 can be swung more largely in the direction intersecting the rotation direction.

The slip preventing part 37 has an cuter shape which is similar to and slightly larger than the outer shape of the base body 31 (a rectangular shape), as illustrated in FIGS. 1 to 4. The slip preventing part 37 is made of rubber. In the first base 30A placed in abutment on the top surface of the furniture F, the slip preventing part 37 is fitted in a lower opening of the base body 31. Furthermore, the slip preventing part 37 is substantially flat in shape. In more detail, in the slip preventing part 37, a surface which abuts against the top surface of the furniture F or the ceiling C is flat, and an oppositely directed surface (the surface opposed to the base body 31) is formed with a fitting groove according to an outer peripheral wall of the base body 31 and the ribs R1 and R2. The slip preventing part 37 is detachably attached to the base body 31 by an elastic force thereof.

The following will describe a step of assembling the damper 10 with the bases 30A and 30B.

First, the bushes 35 are respectively fitted into the through holes 15A formed through the two joints 15 provided at both ends of the damper 10 thereby to be attached to the joints 15 of the damper 10.

Next, one of the joints 15 of the damper 10 attached with the bush 35 is inserted between the paired convex portions 43 formed on the base body 31. The shaft part 45B of the bolt 45 is then inserted through the insertion holes 43B of the base body 31 and the bush 35, and the nut 47 is screwed onto the shaft part 45B of the bolt 45. The base body 31 is thus coupled to one of the joints 15 of the damper 10. The other joint 15 of the damper 10 is also coupled to the other base body 31 in the similar manner. In this state, as illustrated in FIG. 2, the heads 45A of the bolts 45 and the nuts 47 (both ends of the rotating shaft members) are respectively exposed in the recesses 42 of the base bodies 31 at positions symmetrical with respect to a central axis of the damper 10.

Then, the slip preventing parts 37 are respectively fitted with the base bodies 31 coupled to both ends of the damper 10, so that the step of assembling the damper 10 with the bases 30A and 30B is finished.

In the damper 10 and the bases 30A and 30B thus assembled, the bushes 35 are respectively rotatable relative to the shaft parts 45B of the bolts 45 as illustrated in FIG. 3. Accordingly, both ends of the damper 10 are respectively coupled to the bases 30A and 30B so as to be rotatable about the rotation axes. Furthermore, both ends of the bush 35 have the inner peripheral surfaces 35C the diameters of which are outwardly enlarged. Accordingly, the bush 35 is inclinable relative to the rotation axis to the extent that the inner peripheral surfaces 35C of both ends thereof having enlarged diameters abut against the outer peripheral surface of the shaft part 45B of the bolt 45. More specifically, the damper is swung due to the dimensional allowance and the enlarged diameters of the inner peripheral surfaces 35C. Furthermore, the bush 35 is an elastic body and by the elastic deformation thereof, the damper 10 can be swung more largely in a direction intersecting the rotation direction. Thus, the damper 10 coupled to the bases 30A and 30B is swingable in the direction intersecting the rotation direction.

The fall preventing part 50 is formed by bending a flat band-shaped metal, or formed of resin, as illustrated in FIGS. 1, 4, and 5. The fall preventing part 50 has a constant width that is slightly smaller than that of the groove 41 formed in the base body 31. In other words, the width of the fall preventing part 50 is slightly smaller than a length of the slit-like locked hole 49 formed in the base body 31. Furthermore, the fall preventing part 50 has a coupling part 51 and a drooping part 53. The coupling part 51 has a locking part 51A formed by bending one of ends thereof at a right angle. The drooping part 53 is continuous to the other end of the coupling part 51 and perpendicular to the coupling part 51 and extends in the same direction as the locking part 51A. The drooping part 53 of the fall preventing part 50 has a length set so as not to come out from between the wall surface W and the rear surface of the furniture F when the overturn preventing device falls in such a direction that an upper side thereof departs from the wall surface W, as described later. For example, the drooping part 53 has a length of not less than 100 mm below the slip preventing part 37.

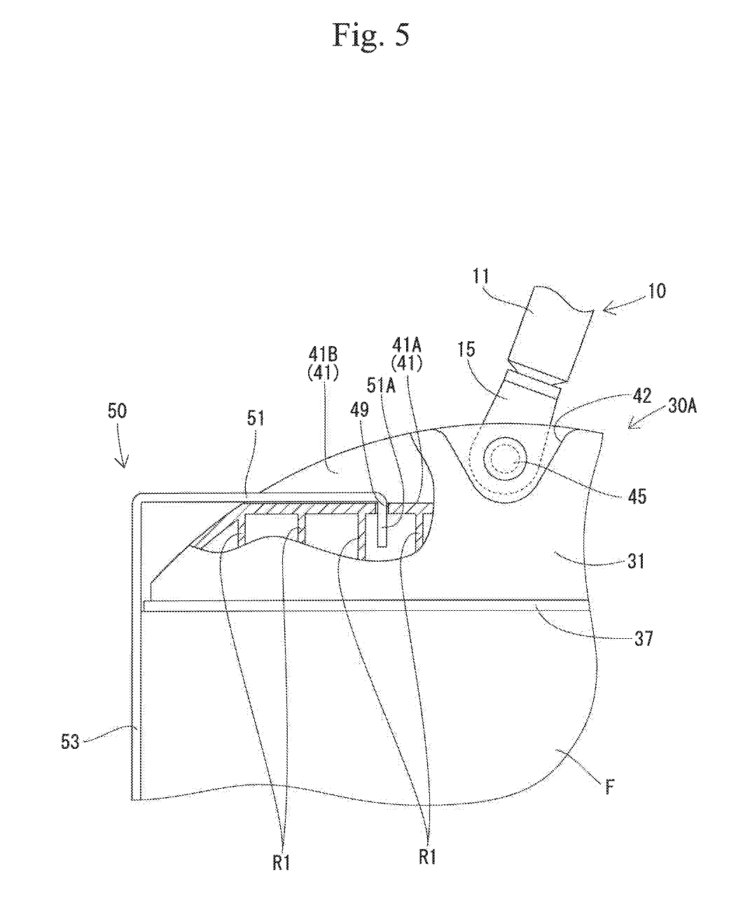

The fall preventing part 50 is attached to the first base 30A placed in abutment on the top surface of the furniture F as illustrated in FIGS. 1 and 5. In more detail, the locking part 51A of the coupling part 51 is inserted and locked in the locked hole 49 of the base body 31 of the first base 30A placed in abutment on the top surface of the furniture F, which locked hole 49 is located at the wall surface W side. Thus, the fall preventing part 50 can be easily attached to the first base 30A it this overturn preventing device. Furthermore, the fall preventing part 50 can be detached from the first base 30A during the packaging of the overturn preventing device or in other cases so that the overturn preventing device is prevented from bulking.

In a state of being attached to the base body 31 of the first base 30A, the coupling part 51 of the fall preventing part 50 extends along the groove 41 formed in the base body 31 and the other end of the coupling part 51 is located outside an outer edge of the first base 30A (an outer edge of the slip preventing part 37 of the first base 30A). The drooping part 53 droops from the other end of the coupling part 51 and extends downward slightly outside the outer edge of the slip preventing part 37 of the first base 30A. The fall preventing part 50 is disposed between the wall surface W and the rear surface of the furniture F below the first base 30A,

The angle regulator 70 is detachably attached to the first base 30A placed in abutment on the top surface of the furniture F as illustrated in FIGS. 1, 2, and 6. As a result, the angle regulator 70 can be detached from the first base 30A during the packaging of the overturn preventing device or in other cases so that the overturn preventing device is prevented from bulking. In a state of being attached to the first base 30A, the angle regulator 70 has a regulating part 71 which extends substantially vertically, and a support part 73 which is provided to be continuous from a lower part of the regulating part 71 and prevents the regulating part 71 from being inclined. The regulating part 71 is a flat plate and is substantially rectangular in shape. When the angle regulator 70 is attached to the first base 30A placed in abutment on he top surface of the furniture F, one of short side ends of the regulating part 71 serves as a receiving part 71A located at an upper end, and the other short side end is located at a lower end and serves as the insertion part 71B which is inserted into the locked hole 49 of the base body 31 located at the side away from the wall surface W.

The regulating part 71 causes the cylinder 11 of the damper 10 to abut against the receiving part 71A thereby regulating the damper 10 so as not to fall in excess of the inclined state. An inclination angle of the damper 10 preferably ranges from 15° to 25°. The receiving part 71A is upwardly open and curved so as to be downwardly recessed at a central part thereof so that one third of the outer periphery of the cylinder 11 abuts thereagainst. Thus, since the cylinder 11 is not held by the receiving part 71A, the movement of the damper 10 is not restrained when the furniture F is tilted or shaken by shaking of earthquake or the like. In other words, in this overturn preventing device, the damper 10 is rotatable about the rotation axes relative to the bases 30A and 30B and swingable in the direction intersecting the rotation direction when the furniture F is shaken or tilted by shaking of earthquake or the like.

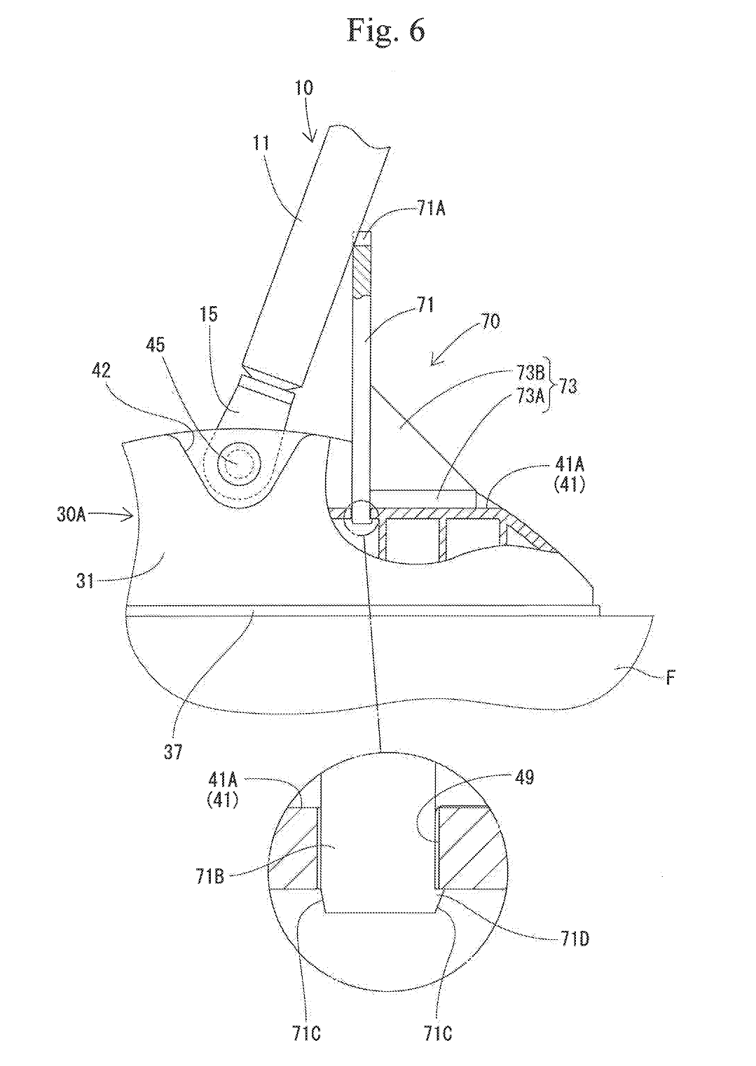

The insertion part 71B has inclined surfaces 71C respectively formed by cutting out both side corners of the short side in the long side direction so as to become thinner toward a distal end thereof, as illustrated in FIG. 6. The inclined surfaces 71C allow the insertion part 71B to be easily inserted into the locked hole 49 of the base body 31. The insertion part. 71B also has protrusion 71D protruding from one of sides of the distal end in the short side direction. The angle regulator 70 is detachable from the first base 30A. However, when a force acts on the angle regulator 70 in such a direction that the insertion part 71B is accidentally pulled out of the locked hole 49 of the base body 31, the protrusion 71D is caught by the locked hole 49, whereby the insertion part 71B is hard to pull out of the locked hole 49.

The support part 73 includes a first support part 73A and a second support part 73B. The first support part 73A has the same width as the regulating part 71 and is a flat plate extending in a direction perpendicular to the regulating part 71. The first support part 73A abuts against the bottom 41A of the groove 41 formed in the base body 31 when the insertion part 71B of the regulating part 71 is inserted into the locked hole 49 of the base body 31 of the first base 30A. The second support part 73B is a flat plate which has an isosceles right triangle shape and is coupled to a corner between the first support part 73A and the regulating part 71. In more detail, the second support part 73B has two sides having an equal length which are respectively coupled to a side surface of the first support part 73A and a side surface of the regulating part 71, thereby supporting the regulating part 71 so that the first support part 73A and the regulating part 71 are perpendicular to each other.

The overturn preventing device includes a fixing cord 90 to maintain the damper 10 in a contracted state with a desired length, as illustrated in FIG. 7. The fixing cord 90 is a string made of a chemical fiber. While the damper 10 is in a contracted state, both sides of the fixing cord 90 are respectively formed into rings, which rings are respectively caught on the heads 45A of the bolts 45 and the nuts 47 of the first and second bases 30A and 30B. In other words, the fixing cord 90 is locked on the heads 45A of the bolts 45 and the nuts 47 of the first and second bases 30A and 30B at both sides thereof and extends as a single cord in the middle thereof.

Thus, in this overturn preventing device, the damper 10 can be held in the contracted state with a desired length by use of the heads 45A of the bolts 45 and the nuts 47 respectively located at both ends of the damper 10, without providing the structure only for locking the fixing cord 90. Furthermore, in this overturn preventing device, the damper 10 can be held in contracted states with different contraction lengths by adjusting the length of the cord. As a result, even with the overturn preventing device having the same lengths of the cylinder 11 and the rod 13, possible to prepare a plurality of overturn preventing devices which hold the damper 10 in a plurality of contracted states with different contraction lengths according to the distance between the top surface of the furniture F and the ceiling C where the overturn preventing device is to be mounted. Furthermore, even when a standard of the length of the damper 10 is changed, the overturn preventing device can easily cope with the change by changing the length of the fixing cord 90.

When the overturn preventing device is mounted between the top surface of the furniture F and the ceiling C, the first base 30A of the overturn preventing device maintained in the contracted state by the fixing cord 90 is placed in abutment on the top surface of the furniture F. Subsequently, when the fixing cord 90 is loosened or cut, the damper 10 is extended by an expansion force of the compressed gas filling the cylinder 11 with the result that the second base 30B abuts against the ceiling C. Thus, since the worker need not carry out a mounting work to contract the damper 10 above the furniture F, the overturn preventing device can be mounted between the top surface of the furniture F and the ceiling C easily and safely.

Furthermore, if the degree of extension of the damper 10 is rendered small when the damper 10 changes from the state contracted by the fixing cord 90 to the state where the second base 30B abuts against the ceiling C, shock caused by abutment of the second base 30B against the ceiling C can be rendered small. Therefore, according to a distance between the top surface of the furniture F and the ceiling C, a plurality of types of overturn preventing devices having different lengths of the cylinder 11 and the rod 13 of the damper 10 preferably may be prepared, and furthermore, a plurality of types of overturn preventing devices having different contraction lengths of the damper 10 preferably may be prepared by use of the fixing cord 90 for the damper 10 having the same lengths of the cylinders 11 and the rods 13.

The following will describe a manner of mounting the overturn preventing device between the top surface of the furniture F installed on the floor with the rear surface thereof being opposed to the wall surface W, and the ceiling C.

First, one of the overturn preventing devices is selected which has the suitable lengths of the cylinder 11 and the rod 13 for the distance between the ceiling C and the top surface of the furniture where the overturn preventing device is to be mounted and which has the damper 10 being maintained in the contracted state by the fixing cord 90 with an appropriate length so that shock caused by abutment of the second base 30B against the ceiling C is rendered small.

Next, the locking part 51A of the fall preventing part 50 is inserted into one of the locked holes 49 formed in the base body 31 of the first base 30A of the overturn preventing device, whereby the fall preventing part 50 is attached to the first base 30A. The insertion part 71B of the angle regulator 70 is inserted into the other locked hole 49 formed in the base body 31 of the first base 30A whereby the angle regulator 70 is attached to the first base 30A.

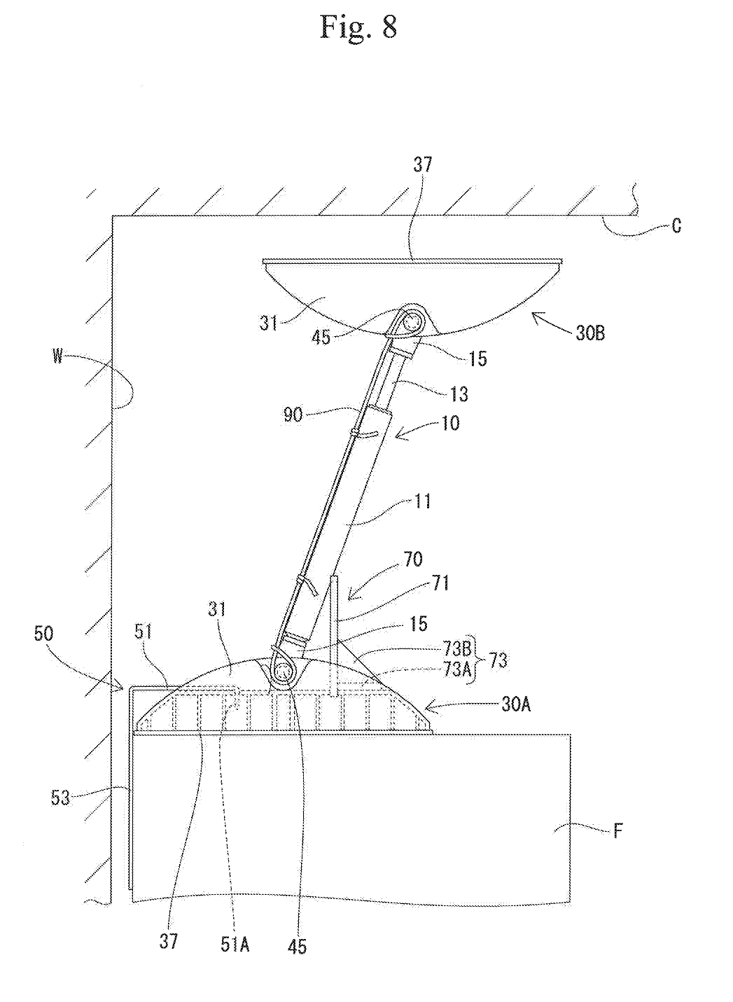

Next, the first base 30A attached with the fall preventing part 50 and the angle regulator 70 is placed with the slip preventing part 37 abutting against the top surface of the furniture F at the wall surface W side, as illustrated in FIG. 8. In this case, the first base 30A is placed on the top surface of the furniture F in such a manner that the drooping part 53 of the fall preventing part 50 droops along the rear surface of the furniture F. In other words, the drooping part 53 of the fall preventing part 50 is disposed between the wall surface W and the rear surface of the furniture F. Furthermore, in the state where the first base 30A is placed on the top surface of the furniture F, the shaft part 45B (rotation axis) of the bolt 45 of the first base 30A extends in a direction perpendicular to a direction in which the furniture F is tilted by shaking of earthquake or the like (rightward as viewed in FIG. 8). In other words, the first base 30A is placed on the top surface of the furniture F so that the direction in which the damper 10 is rotated about the rotation axes is parallel to the direction in which the furniture F is tilted.

The damper 10 is then inclined so that the cylinder 11 of the damper 10 abuts against the receiving part 71A of the angle regulator 70. In this state, the damper 10 is inclined at an appropriate angle ranging from 15° to 25°. The direction of the second base 30B is corrected so that the shaft part 45B (the rotation axis) of the bolt 45 of the second base 30B becomes parallel to the shaft part 45B (the rotation axis) of the bolt 45 of the first base 30A. When the fixing cord 90 is loosened or cut in this state, the damper 10 is extended by an expansion force of the compressed gas filling the cylinder 11, with the result that the second base 30B abuts against the ceiling C. Thus, the work for mounting the overturn preventing device between the top surface of the furniture F and the ceiling C is completed. The angle regulator 70 may be detached from the first base 30A after completion of the mounting work.

As described above, the damper 10 of the overturn preventing device can be inclined at the appropriate inclination angle by placing the first base 30A attached with the angle regulator 70 on the top surface of the furniture F, and the overturn preventing device can be mounted appropriately between the top surface of the furniture F and the ceiling C just by causing the second base 30B to abut against the ceiling C while maintaining the inclination angle of the damper 10.

In the overturn preventing device mounted between the top surface of the furniture F and the ceiling C, the damper 10 is mounted so that an axis line of the damper 10 extending from the ceiling C side to the top surface side of the furniture F is downwardly inclined and so that the axis line of the damper 10 extends in parallel to the direction in which the furniture F is tilted by shaking of earthquake or the like (rightward) in a planar view as viewed from above. Accordingly, the overturn preventing device can prevent the furniture F from overturn by effectively using the damping force of the damper 10 for the tilt of the furniture F.

Furthermore, both ends of the damper 10 are respectively coupled via the bushes 35 to the bases 30A and 30E. Each bush 35 has both ends further having the inner peripheral surfaces 35C the diameters of which are outwardly enlarged. Consequently, each bush 35 is swung due to the dimensional allowance and the enlarged diameters of the inner peripheral surfaces 35C, each bush 35 can be inclined with respect to the rotation axis to the extent that the inner peripheral surfaces 35C of both ends thereof having enlarged diameters abut against the outer peripheral surface of the shaft part 45B of the bolt 45. As a result, the damper 10 coupled to the bases 30A and 30B can be swung in the direction intersecting with the rotation direction.

Thus, even when the furniture F is shaken in the direction intersecting the rotation direction by shaking of earthquake or the like, the damper 10 is swung in the direction intersecting the rotation direction with the result that the bases 30A and 30B can respectively be maintained in abutment against the top surface of the furniture F and the ceiling C. When the furniture F is tilted in the direction parallel to the rotation direction of the damper 10, the damper 10 is rotated about the rotation axes so that the damping force of the damper 10 acts on the furniture F thereby suppressing tilt of the furniture F, with the result that the furniture F can be prevented from overturn. In other words, the bases 30A and 30B can be respectively maintained in abutment against the top surface of the furniture F and the ceiling C against earthquake or the like with multidirectional shaking, with the result that the furniture F can be prevented from over

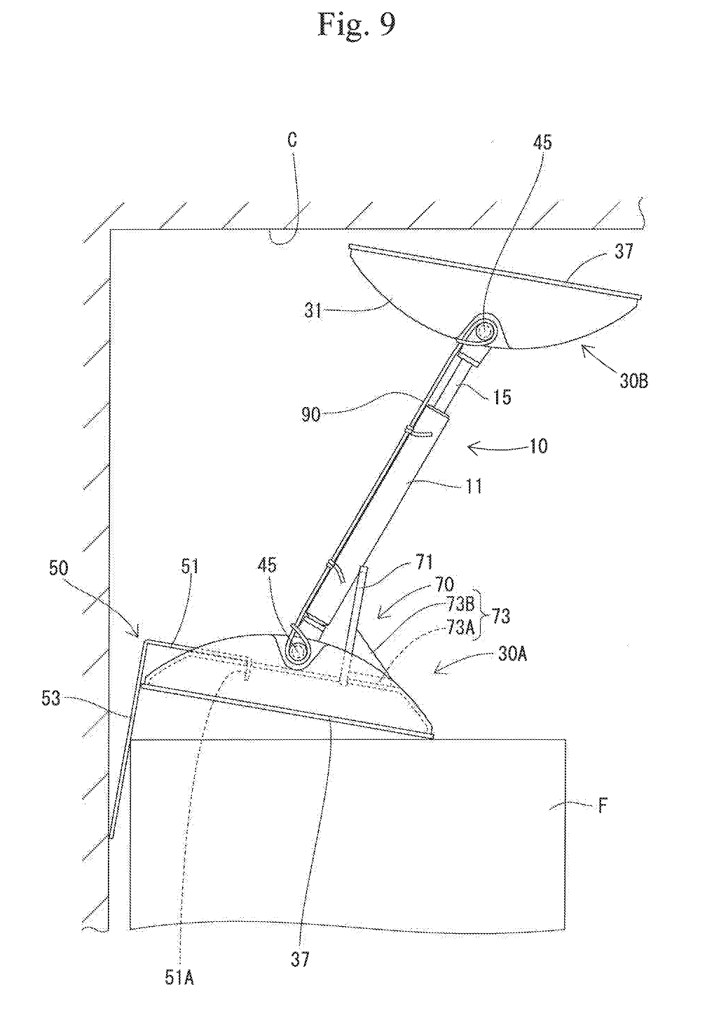

Furthermore, consider the case where the overturn preventing device falls in such a direction that the upper side thereof departs from the wall surface W before the second base 30B is caused to abut against the ceiling C during the work of mounting the overturn preventing device between the top surface of the furniture F and the ceiling C, that is, when the first base 30A is placed in abutment on the top surface of the furniture F and the drooping part 53 of the fall preventing part 50 is disposed between the wall surface W and the rear surface of the furniture F. In this case, due to the force to tilt the overturn preventing device, the wall surface W side of the first base 30A abutting against the top surface of the furniture F is caused to float. Thereupon, as illustrated in FIG. 9, the drooping part 53 of the fall preventing part 50 attached to the first base 30A is caught on the wall surface W. As a result, the overturn preventing device can be prevented from falling to the front surface side of the furniture F.

As described above, the overturn preventing device of the first embodiment includes the damper 10, the paired bases 30A and 30B, and the fixing cord 90. The damper 10 is mounted between the top surface of the furniture F installed on the floor, and the ceiling C. Both ends of the damper 10 are respectively coupled to the bases 30A and 30B. Furthermore, the first base 30A abuts against the top surface of the furniture F, and the second base 30B abuts against the ceiling C. The fixing cord 90 maintains the damper 10 in the contracted state with the desired length.

The first base 30A is placed in abutment on the top surface of the furniture F while the damper 10 is held in the contracted state with the desired length by the fixing cord 90. And after the damper 10 has been positioned in the mounting state so that the damper 10 extends in a desired direction, the fixing cord 90 is loosened or cut. Thereupon, the damper 10 is extended with the result that the second base 30B abuts against the ceiling C, whereby the mounting work can be completed. Thus, since the worker does not need to carry out the mounting work above the furniture F while contracting the damper 10, the overturn preventing device can easily be mounted between the top surface of the furniture F and the ceiling C.

Accordingly, the overturn preventing device can easily be mounted between the top surface of the furniture F and the ceiling C.

The bases 30A and 30B of the overturn preventing device of the first embodiment are respectively provided with the rotating shaft members (the bolts 45 and the nuts 47) which rotatably supports both ends of the damper 10. The fixing cord 90 is locked on rotating shaft members (the bolts 45 and the nuts 47). As a result, the damper 10 can be held in the contracted state with the desired length by use of the rotating shaft members (the bolts 45 and the nuts 47) respectively located at both ends of the damper 10 without providing of the structure only for locking the fixing cord 90.

The heads 45A of the bolts 45 and the nuts 47 (both ends of the rotating shaft members) are respectively exposed from the bases 30A and 30B at positions symmetrical with respect to a central axis of the damper 10. Furthermore, the fixing cord 90 is locked on the heads 45A of the bolts 45 and the nuts 47 of the first and second bases 30A and 30B at both sides thereof and extends as a single cord in the middle thereof. In this case, the damper 10 can be held in the contracted state in a balanced manner since the fixing cord 90 which is locked on the heads 45A of the bolts 45 and the nuts 47 at both ends thereof extends as a single cord in the middle part thereof.

The overturn preventing device of the first embodiment is provided with the angle regulator 70. The angle regulator 70 is attached to the first base 30A abutting against the top surface of the furniture F and regulates the inclination angle of the damper 10. As a result, when the first base 30A of the overturn preventing device is placed in abutment on the top surface of the furniture F, the damper 10 is disposed at a desired inclination angle by the angle regulator 70. And when the fixing cord 90 is loosened or cut in this state, the overturn preventing device can be mounted between the top surface of the furniture F and the ceiling C with the damper 10 being set at the desired inclination angle.

### Second Embodiment

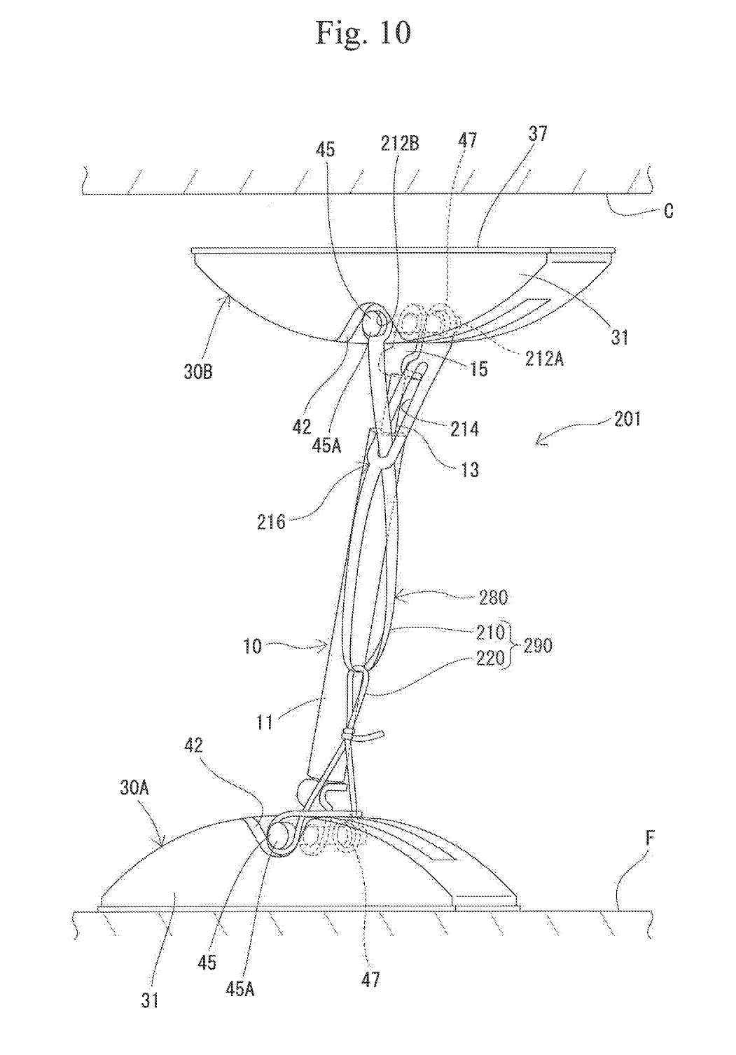

A second embodiment will be described with reference to FIGS. 10 to 13 and the like.

The overturn preventing device 201 of the second embodiment as illustrated in FIG. 10 and the like differs from that of the first embodiment in that the fixing cord 90 (FIG. 7 and the like) has been changed to a fixing cord 290 as illustrated in FIG. 10 and the like. Other construction is same as that of the first embodiment and has the same function. Accordingly, except for the fixing cord 290, identical or similar parts are labeled by the same reference symbols as those in the first embodiment, and the detailed description of these parts will be eliminated. Although the furniture F installed on the installation surface is also exemplified as the article in the following description, the overturn preventing device may be applied to an article other than the furniture.

The overturn preventing device 201 as illustrated in FIG. 10 includes the damper 10 and the paired bases 30A and 30B all of which are similar to those in the first embodiment. The damper 10 is mounted between the top surface of the furniture F and the ceiling C in the mounting of the overturn preventing device 201. The paired bases 30A and 30B are respectively coupled to both ends of the damper 10. The first base 30A abuts against the top surface of the furniture F, and the second base 30B abuts against the ceiling C in use of the overturn preventing device 201. The overturn preventing device 201 further includes the angle regulator 70 having the same structure and function as that in the first embodiment. The angle regulator 70 is attached to the first base 30A abutting against the top surface of the furniture F and regulates the inclination angle of the damper 10. The overturn preventing device 201 further includes the fall preventing part 50 having the same structure and function as that in the first embodiment.

In the overturn preventing device 201, the bolt 45 and the nut 47 attached to the first base 30A function as the rotating shaft member at one side. The bolt 45 and the nut 47 attached to the second base 30B functions as a rotating shaft member at the other side. The head 45A of the bolt 45 and the nut 47 serving as both ends of each rotating shaft member are respectively exposed in the recesses 42 of the base body 31 at positions symmetrical with respect to the central axis of the damper 10. The fixing cord 290 includes a part at one end side which is locked on the bolt 45 and the nut 47 both mounted on the first base 30A, and a part at the other end side which is locked on the bolt 45 and the nut 47 both mounted on the second base 30B. The fixing cord 290 is attached to the first and second bases 30A and 30B in this form.

The fixing cord 290 is a member regulating an increase in the distance between both bases 30A and 30B and holds the damper 10 in the contracted state with the desired length when attached to the bases 30A and 30B as illustrated in FIG. 10. The fixing cord 290 includes a band member 210 formed of a resin material and a coupling part 220 at an article side which includes a string or the like made of a chemical fiber. The band member 210 and the coupling part 220 are coupled to each other thereby constituting the fixing code 290.

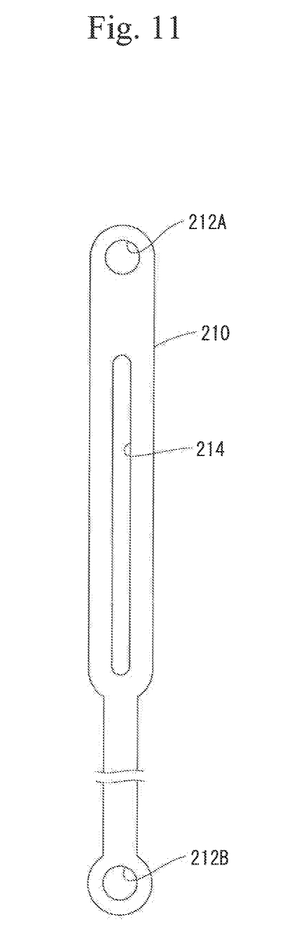

The band member 210 is formed of the resin material or the like such as polypropylene and composed into a band member having an elongate shape and a predetermined thickness. The band member 210 is configured to be easily flexible but has a suppressed stretchability. The band member 210 is long and thin in an extended shape as illustrated in FIG. 11. The band member 210 is formed with a through hole part 212A located at one longitudinal side and penetrating therethrough in a thickness direction and a through hole part 212B located at the other longitudinal side and penetrating therethrough in the thickness direction. An elongate hole part 214 is formed at a location that is nearer to a central part than the through hole part 212A at the longitudinal one side of the band member 210. The elongate hole part 214 extends through the band member 210 in the thickness direction and is elongate in the longitudinal direction of the band member 210.

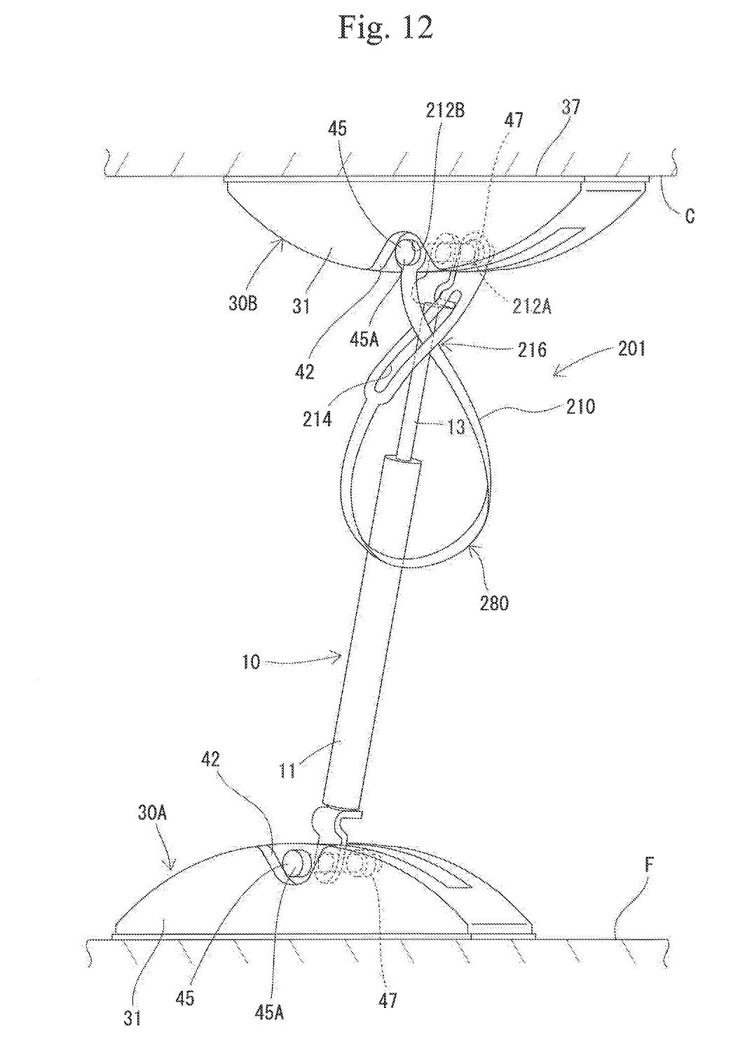

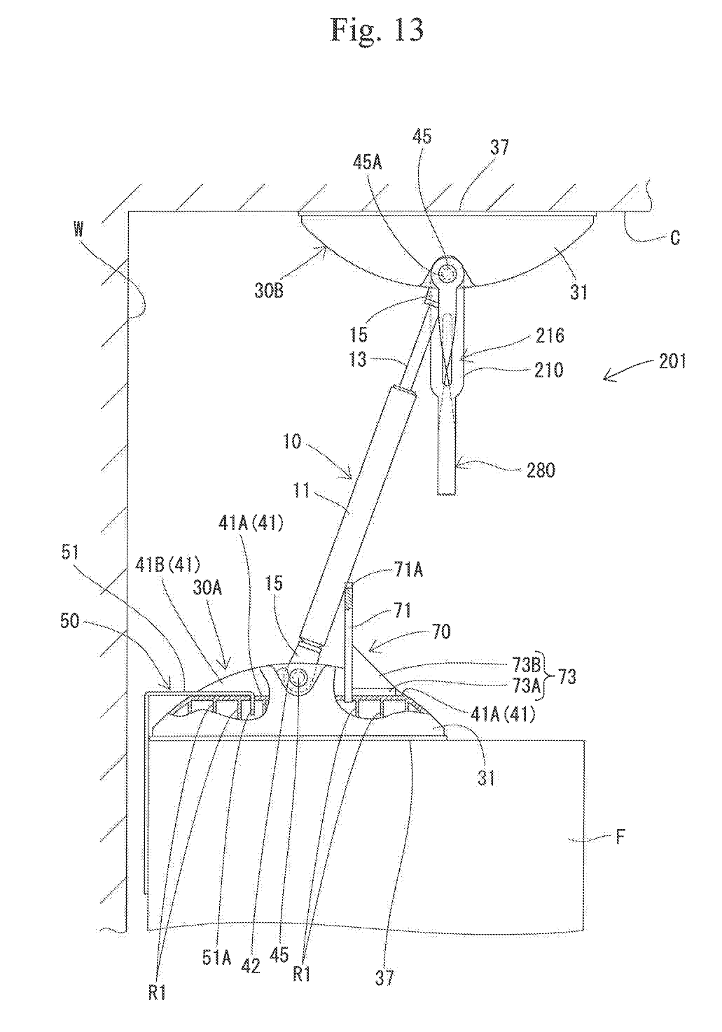

From the extended state as illustrated in FIG. 11, the longitudinal other side end (the end at the through hole part 212B side) of the band member 210 is caused to enter and pass through the elongate hole part 214 so that the band member 210 gets crossed as illustrated in FIG. 10. In the crossed state of the band member 210, there is formed a crossed part 216 in which a part located near the longitudinal one end (a part forming the elongate hole part 214) and a part located near the longitudinal other end are crossed each other. In this crossed state, the through hole part 212A formed at one side of the band member 210 is fitted with the nut 47 thereby to be locked, and the through hole part 212B formed at the other side of the band member 210 is fitted with the head 45A of the bolt 45 thereby to be locked. A central part of the band member 210 in the elongate state as illustrated in FIG. 11 serves as an annular grip 280 when the band member 210 is in the crossed state as illustrated in FIG. 10. The grip 280 is a part the worker grasps to operate the band member 210 when the band member 210 is in a mounted state as illustrated in FIGS. 12 and 13.

The coupling part 220 of the fixing cord 290 located at the article side is disposed to connect the annular part (the grip 280) of the band member 210 disposed in the crossed state and the first base 30A, as illustrated in FIG. 10. The coupling part 220 at the article side is formed of a string or the like made of a chemical fiber and is attached so that the grip 280 of the band member 210 is pulled downward. The length of the damper 10 in the contracted state and the distance between both bases 30A and 30B can be determined by adjusting the length of the coupling part 220 at the article side. In other words, the length of the damper 10 can be increased when a distance between a contact part caught by the grip 280 and the rotating shaft member (the bolt 45 and the nut 47) is rendered longer in the article side coupling part 220. In an opposite manner, the length of damper 10 can be reduced when the distance between the contact part and the rotating shaft member (the bolt 45 and the nut 47) is rendered shorter.

The overturn preventing device 201 in this construction can be mounted in the same manner as that of the first embodiment. First, the first base 30A of the overturn prevent in device 201 held in the contracted state by the fixing cord 290 as illustrated in FIG. 10 is placed in abutment on the top surface of the furniture F in the same manner as in the first embodiment. Although the fall preventing part 50 and the angle regulator 70 are eliminated in FIG. 10, these can be attached in the same manner as in the first embodiment. Either one or both of the fall preventing part 50 and the angle regulator 70 may be eliminated.

After the overturn preventing device 201 in the contracted state has been placed on the top surface of the furniture F, the article-side coupling part 220 is loosened or cut. Thereupon, the damper 10 is extended by an expansion force of the compressed gas filling the cylinder 11, so that the second base 30B abuts against the ceiling C as illustrated in FIGS. 12 and 13. Thus, also in the overturn preventing device 201 in this construction, since the worker need not carry out a mounting work to contract the damper 10 above the furniture F, the overturn preventing device can be mounted between the top surface of the furniture F and the ceiling C easily and safely.

The band member 210 (FIG. 10) forming a part of the fixing cord 290 is hung from the second base 30B when the overturn preventing device 201 has been mounted between the top surface of the furniture F and the ceiling C, as illustrated in FIGS. 12 and 13. In this case, an annular grip 280 is disposed below the crossed part 216 of the band member 210.

The mounting work can be finished if the second base 30B abuts against the ceiling C at a desired location in the case where the overturn preventing device 201 has been mounted between the top surface of the furniture F and the ceiling C as illustrated in FIGS. 12 and 13. In this case, the band member 210 may be detached from the second base 30B or may remain on the second base 30B.

On the other hand, if the second base 30B is not in contact with the ceiling C at a desired location in the mounted state of the overturn preventing device 201 as illustrated in FIGS. 12 and 13 and needs to be relocated, the worker, for example, pulls the annular grip 280 downward while grasping the grip 280. When the grip 280 is pulled downward against the biasing force of the damper 10, the second base 30B can be moved downward to be separated from the ceiling C, so that no frictional force is generated between the second base 30B and the ceiling C. Thus, the second base 30B can be moved to a desired location by moving the grip 280 back and forth or right and left while being separated from the ceiling C. When the pull of the grip 280 is finished at a desired location, the second base 30B abuts against the ceiling C near the desired location thereby to be positioned.

As described above, the overturn preventing device 201 in this construction also can facilitate the mounting work. More specifically, the overturn preventing device 201 can easily be mounted by placing the first base 30A on the top surface of the article when in the contracted state by the fixing cord 290 and by loosening or cutting the article-side coupling part 220.

Furthermore, the grip 280 coupled to the second base 30B abutting against the ceiling C is disposed so as to droop from the second base 30A in the mounted state of the overturn preventing device 201. Accordingly, the worker can separate the second base 30B from the ceiling C against the biasing force of the damper 10 by pulling the grip 280 downward. Thus, since an operation to separate the second base 30B from the ceiling C rendered easier to carry out even after the second base 30B has abutted against the ceiling C, the second base 30B can easily be relocated.

In particular, since the annular grip 280 is placed at the location lower than the second base 30B located at the ceiling side in the mounted state of the overturn preventing device 201, the worker's hand can easily reach and grasp the grip 280 as compared with the case where the second base 30B is directly grasped. Furthermore, the grip 280 is coupled to the rotating shaft member which is located on the central axis of the damper 10 and to which the rod 13 is coupled. As a result, a force in the contraction direction is efficiently applied to the rod 13 when the grip 280 is pulled downward, with the result that the damper 10 can be contracted by a smaller force.

### Third Embodiment

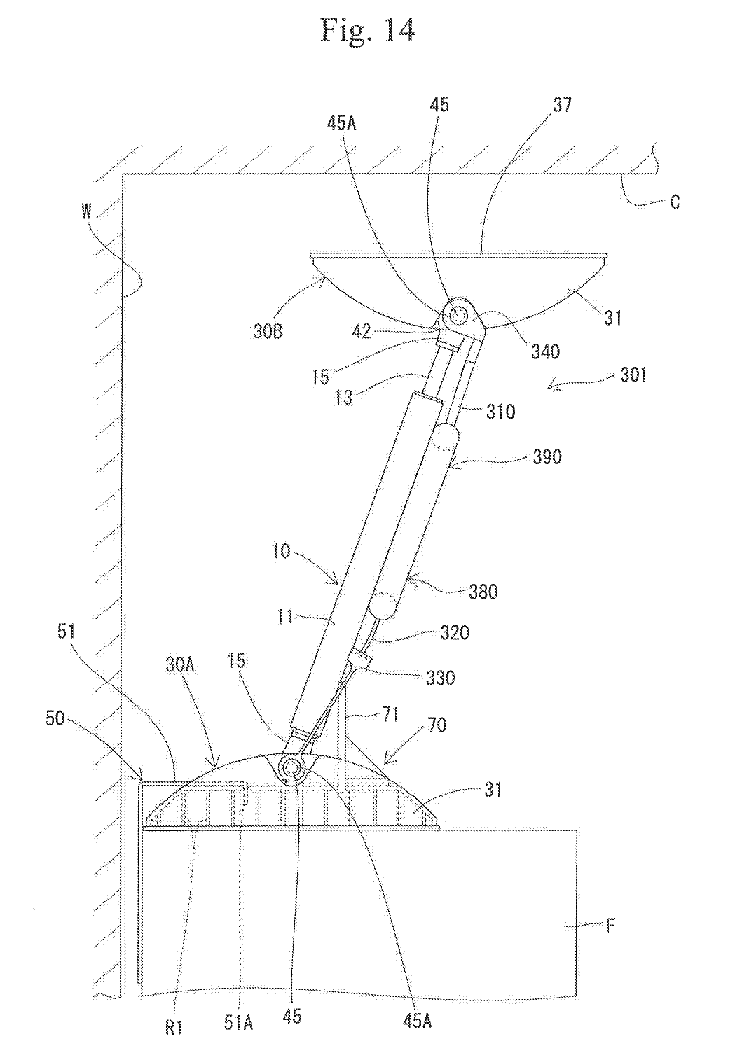

A third embodiment will be described with reference to FIGS. 14 to 18 and the like.

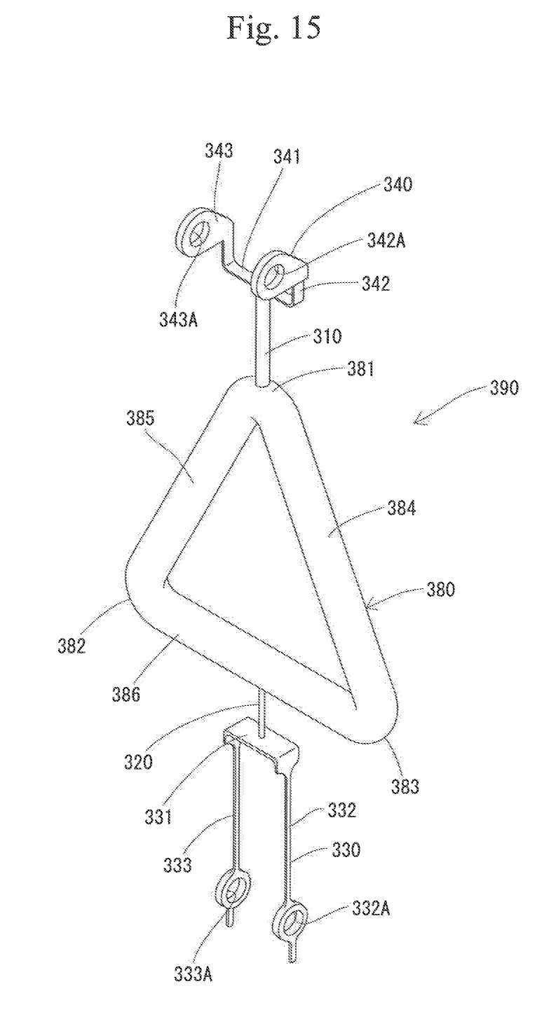

The overturn preventing device 301 of the third embodiment as illustrated in FIG. 14 and the like differs from that of the first embodiment in that the fixing cord 90 (FIG. 7 and the like) has been changed to a fixing cord 390 as illustrated in FIGS. 14, 15 and the like. Other construction is same as that of the first embodiment and has the same function. Accordingly, except for the fixing cord 390, identical or similar parts are labeled by the same reference symbols as those in the first embodiment, and the detailed description of these parts will be eliminated. Although the furniture F installed on the installation surface is also exemplified as the article in the following description, the overturn preventing device may also be applied to an article other than the furniture.

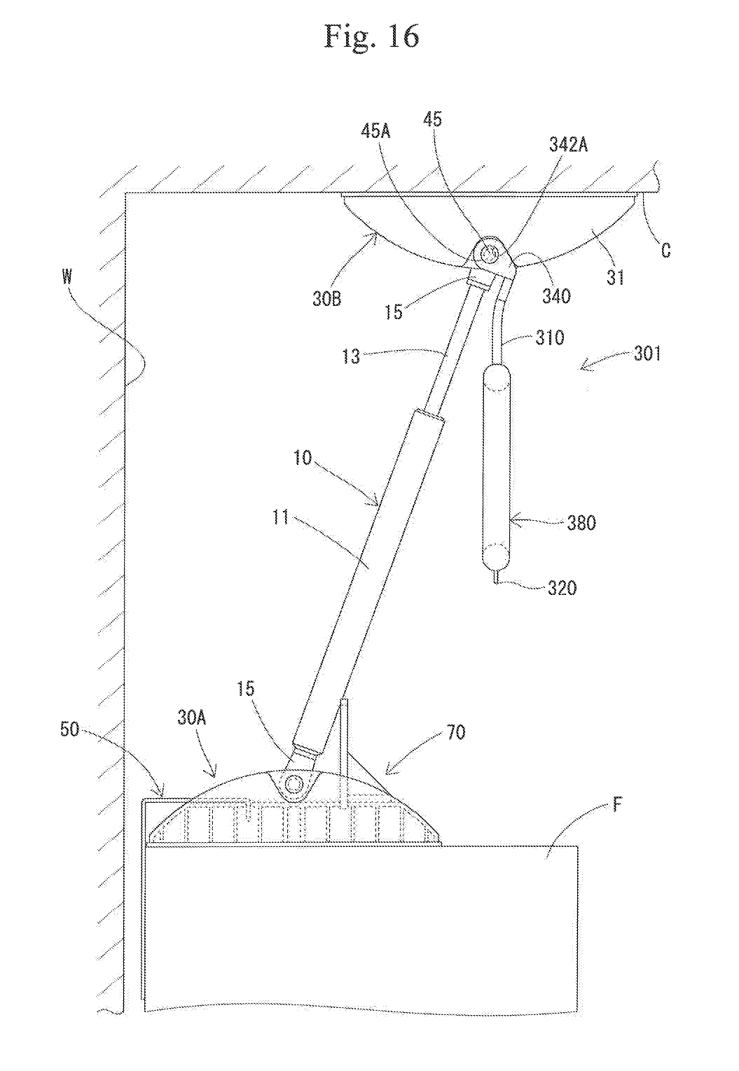

The overturn preventing device 301 as illustrated in FIG. 14 includes the damper 10 and the paired bases 30A and 30B all of which are similar to those in the first embodiment. The damper 10 is mounted between the top surface of the furniture F and the ceiling C in the mounting of the overturn preventing device 201, as illustrated in FIG. 16. The paired bases 30A and 30B are respectively coupled to both ends of the damper 10. The first base 30A abuts against the top surface of the furniture F, and the second base 30B abuts against the ceiling C in use of the overturn preventing device 301. The overturn preventing device 301 further includes the angle regulator 70 and the fall preventing part 50 each having the same structure and function as that in the first embodiment.

The fixing cord 390 as illustrated in FIG. 15 is made of a resin material or the like such as polypropylene and has a first locking part 330 attached to the first base 30A, a second locking part 340 attached to the second base 30B, and the annular grip 380. The fixing cord 390 further includes an article-side coupling part 320 which couples the first locking part 330 and the grip 380 and a ceiling-side coupling part 310 which couples the second locking part 340 and the grip 380. The first locking part 330, the second locking part 340, the grip 380, the article-side coupling part 320, and the ceiling-side coupling part 310 are integrated.

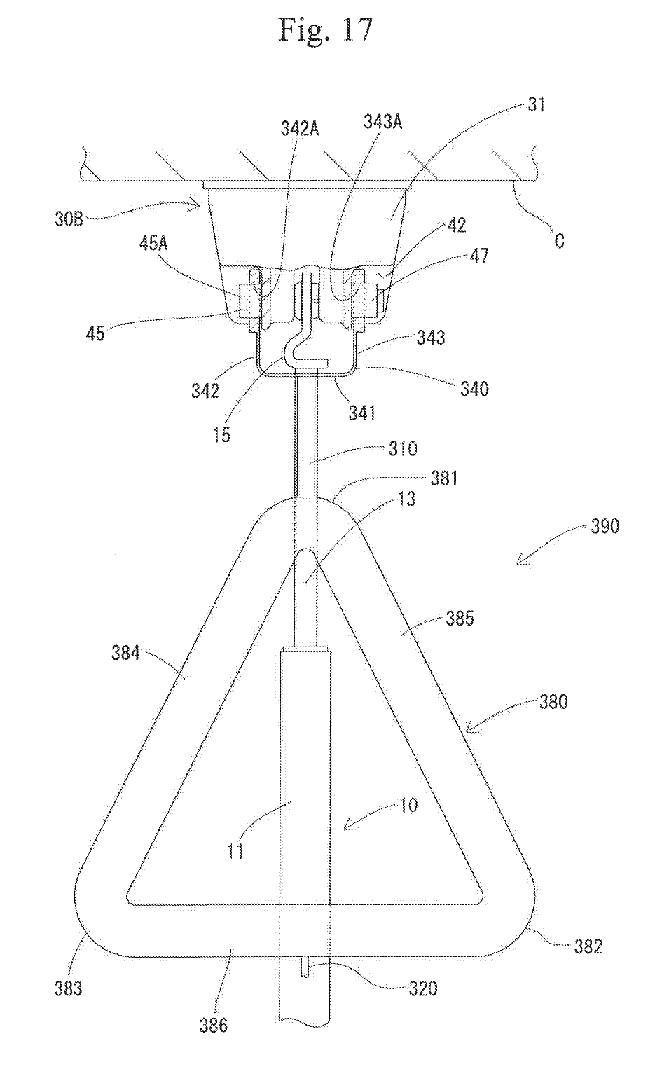

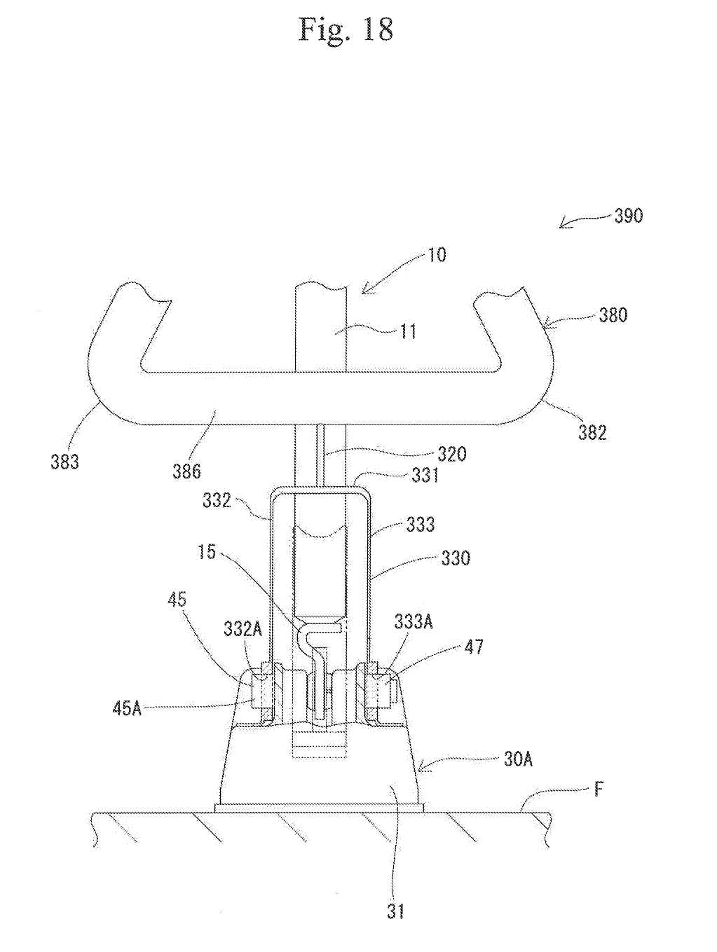

In the overturn preventing device 301, the bolt 45 and the nut 47 both of which are mounted on the first base 30A as illustrated in FIG. 18 function as the rotating shaft member at one side. The bolt 45 and the nut 47 both of which are mounted on the second base 30B as illustrated in FIG. 17 function as the rotating shaft member at the other side. The head 45A of the bolt 45 and the nut 47 serving as both ends of each rotating shaft member are respectively exposed in the recesses 42 of the base body 31 at positions symmetrical with respect to the central axis of the damper 10. The first locking part 330 provided at one end side of the fixing cord 390 is locked on the bolt 45 and the nut 47 mounted on the first base 30A, as illustrated in FIG. 18. The second locking part 340 provided at the other end side of the fixing cord 390 is locked on the bolt 45 and the nut 47 mounted on the second base 30B, as illustrated in FIG. 17. Thus, the fixing cord 390 is attached so as to connect the first and second bases 30A and 30B.

The second locking part 340 includes a root part 341 arranged transversely to the ceiling-side coupling part 310 and a pair of rising parts 342 and 343 rising from the root part 341, as illustrated in FIG. 17. The paired rising parts 342 and 343 are arranged to be opposed to each other. The rising parts 342 and 343 are respectively formed into plate pieces and have plate-shaped surfaces arranged substantially in parallel to each other. The rising parts 342 and 343 are respectively formed with through hole parts 342A and 343A penetrating in the thickness direction which face each other. The one through hole part 342A is fitted with the head 45A of the bolt 45 provided on the second base 30B thereby to be locked, as illustrated in FIG. 17. The other through hole part 343A is fitted with the nut 47 thereby to be locked.

The ceiling-side coupling part 310 is coupled to a longitudinally central part of the root part 341 and extends from the side opposed to a surface side where the rising parts 342 and 343 protrude. An end (a corner 381) of the grip 380 is coupled to one end of the ceiling-side coupling part 310. The ceiling-side coupling part 310 is coupled via the second locking part 340 to the second base 30B abutting against the ceiling C thereby functioning so as to couple the second base 30B and the grip 380.

The grip 380 is coupled to the second base 30B via the second locking part 340 and the ceiling-side coupling part 310 and is hung as illustrated in FIG. 16 in the mounted state of the overturn preventing device 301. The grip 380 is configured to be indicative of a predetermined direction representing a location side of the second base 30B abutting against the ceiling C. More specifically, the grip 380 is formed into a triangular frame shape composed of a plurality of straight parts 384, 385 and 386 connected to one another and further into an annular shape having an open central part, as illustrated in FIGS. 15 and 17. The grip 380 is formed with three corners 381, 382 and 383. The side connected to the corner 381 is the location side of the second base 30B, and the side connected to the middle of the straight part 386 is the location side of the first base 30A. In other words, the location side of the second base 30B abutting against the ceiling is indicated by the direction in which the corner 381 is convex.

In this construction, when either first locking part 330 or second locking part 340 is held and hung, the location side of the second base 30B is indicated by the direction of the triangular frame forming the grip 380 (more specifically, the direction of the corner 381). For example, since the corner 381 is upwardly convex when the second locking part 340 is held and hung, it can be understood that the upper side is the location side of the second base 30B. Furthermore, since the corner 381 is downwardly convex when the first locking part 330 is held and hung, it can be understood that the lower side is the location side of the second base 30B.

The article-side coupling part 320 has a function of coupling the first base 30A abutting against the top surface of the furniture F and the grip 380, as illustrated in FIG. 14 and is a part to be cut in the mounting work. In this construction, the ceiling-side coupling part 310 is thicker than the article-side coupling part 320. More specifically, the ceiling-side and article-side coupling parts 310 and 320 have respective circular cross sections, and the ceiling-side coupling part 310 has a larger outer diameter than the article-side coupling part 320.

The first locking part 330 includes a root part 331 arranged transversely to the article-side coupling part 320 and a pair of drooping parts 332 and 333 drooping from the root part 331, as illustrated in FIG. 15. A central part of the root part 331 is coupled to an end of the article-side coupling part 320. The paired drooping parts 332 and 333 are disposed to be opposed to each other The drooping parts 332 and 333 extend substantially in parallel to each other and are respectively formed with through hole parts 332A and 333A located near distal ends thereof which penetrate therethrough in the thickness direction and face each other. The one through hole part 332A is fitted with the head 45A of the bolt 45 provided on the first base 30A thereby to be locked, as illustrated in FIG. 18. The other through hole part 333A is fitted with the nut 47 thereby to be locked.

The damper 10 is contracted when the fixing cord 390 is to be attached to the first and second bases 30A and 30B. In the contracted state of the damper 10, both locking parts 330 and 340 are respectively attached to both rotating shaft members (the bolts 45 and the nuts 47) of the first and second bases 30A and 30B. As a result, as illustrated in FIG. 14, connection is made between both rotating shaft members so that the extension of the damper 10 is disallowed, whereby the damper 10 is maintained in the contracted state.

The overturn preventing device 301 in this construction can be mounted in the same manner as that of the first embodiment. More specifically, after the overturn preventing device 301 set in the contracted state by the fixing cord 390 has been placed on the top surface of the furniture F as illustrated in FIG. 14 the article-side coupling part 320 or the first locking part 330 is cut. Thereupon, the expansion force of the compressed gas filling the cylinder 11 extends the damper 10, so that the second base 30B abuts against the ceiling C as illustrated in FIG. 16. Thus, also in the overturn preventing device 301 in this construction, since the worker need not carry out the mounting work to contract the damper 10 above the furniture F, the overturn preventing device can be mounted between the top surface of the furniture F and the ceiling C easily and safely.

As illustrated in FIG. 16, when the overturn preventing device 301 has been mounted between the ceiling C and the furniture F, the grip 380 which is a part of the fixing cord 390 (FIG. 14) is hung via the article-side coupling part 310 from the second base 30B. In such a mounted state, the mounting work can be finished if the second base 30B abuts against the ceiling C at a desired location. In this case, the cut fixing cord 390 may be detached or may remain.

On the other hand, if the second base 30B is not in contact with the ceiling C at a desired location in the mounted state and needs to be relocated, the same moving operation as that in the second embodiment should be carried out. For example, the worker should contract the damper 10 by pulling the grip 380 downward while grasping the annular grip 380, thereby moving the grip 380 back and forth or right and left with the second base 30B being kept away from the ceiling C. As a result of this operation, the second base 30B can be moved to a desired location, and when the pull of the grip 380 is finished at a desired location, the second base 30B abuts against the ceiling C near the desired location thereby to be positioned.

As described above, also in the overturn preventing device 301 in this construction, the operation to move the second base 30B away from the ceiling C is rendered easier to carry out even after the second base 30B has been mounted on the ceiling C. As a result, the second base 30B can easily be relocated.

Furthermore, the grip 380 is configured to be indicative of a predetermined direction representing the location side of the second base 30B abutting against the ceiling C. When the grip 380 is thus configured to be indicative of the predetermined direction, the worker can understand the mounting direction of the fixing cord 390 more easily. For example, an error can be reduced that the fixing cord 390 is mounted upside down on both bases 30A and 30B. Furthermore, when both bases 30A and 30B to both of which the fixing cord 390 has been attached are respectively mounted on the furniture F and the ceiling C, the worker can confirm the base to be mounted at the ceiling side and the base to be mounted at the article side on the basis of the shape indicative of the direction represented by the grip 380. This can reduce an error that the first base 30A to be disposed at the furniture F side and the second base 30B to be disposed at the ceiling C side are mounted in reverse.

Furthermore, the ceiling-side coupling part 310 is thicker than the article-side coupling part 320. When the ceiling-side coupling part 310 is thicker than the article-side coupling part 320, the strength of the ceiling-side coupling part 310 can be enhanced, and the cutting or the like of the article-side coupling part 320 can he performed easily. When the strength of the ceiling-side coupling part 310 is enhanced, breakage or the like is less likely to occur even if a great force is applied between the grip 380 and the second base 30B when the grip 380 is pulled downward to be separated from the ceiling after the second base 30B has been mounted on the ceiling.

### Fourth Embodiment

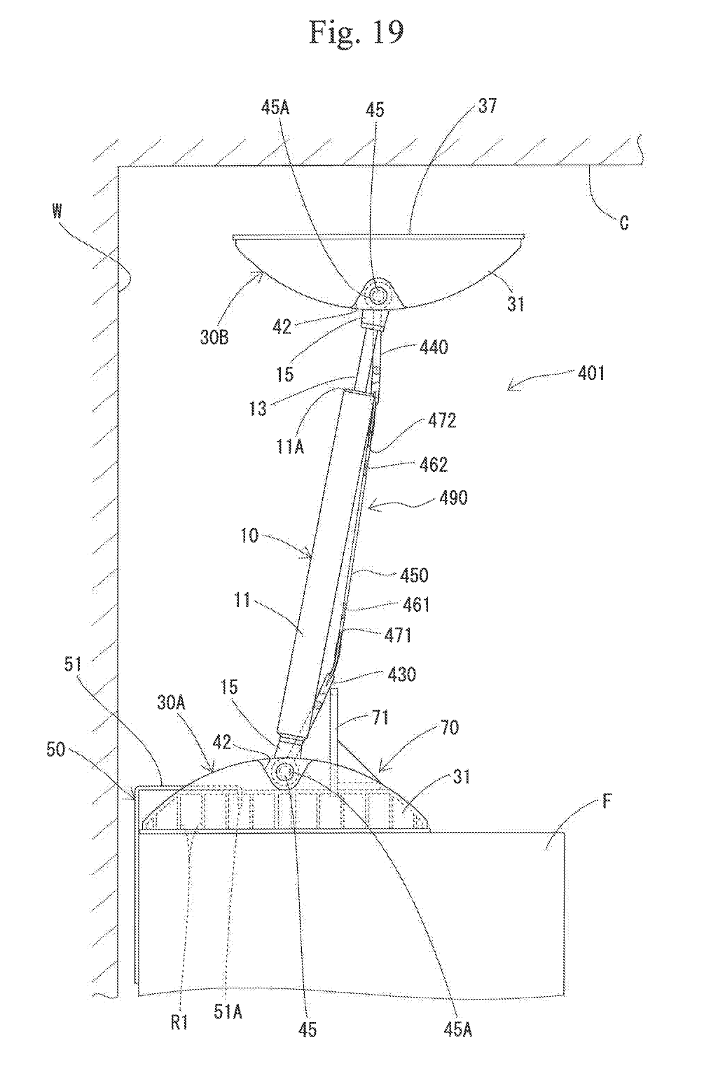

A fourth embodiment will be described with reference to FIGS. 19 to 23 and the like.

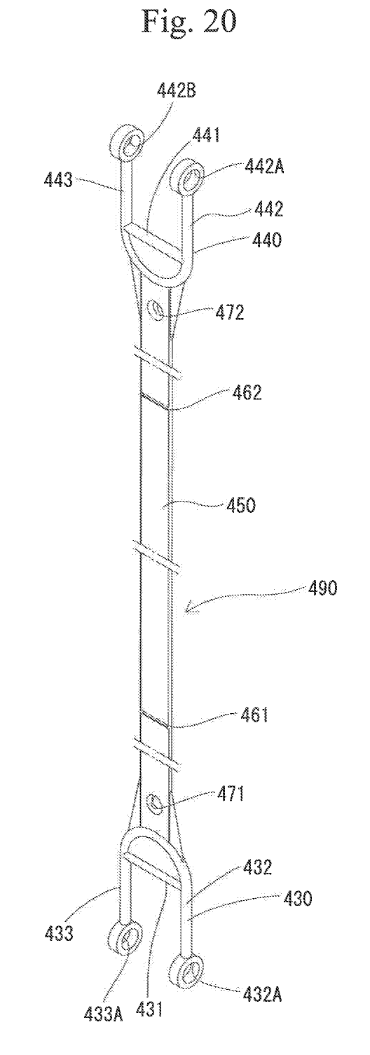

The overturn preventing device 401 of the fourth embodiment as illustrated in FIG. 19 and the like differs from that of the first embodiment in that the fixing cord 90 (FIG. 7 and the like) has been changed to a fixing cord 490 as illustrated in FIGS. 19 and 20. Other construction is same as that of the first embodiment and has the same function. Accordingly, except for the fixing cord 490, identical or similar parts are labeled by the same reference symbols as those in the first embodiment, and the detailed description of these parts will be eliminated. Although the furniture F installed on the installation surface is also exemplified as the article in the following description, the overturn preventing device may also be applied to an article other than the furniture.

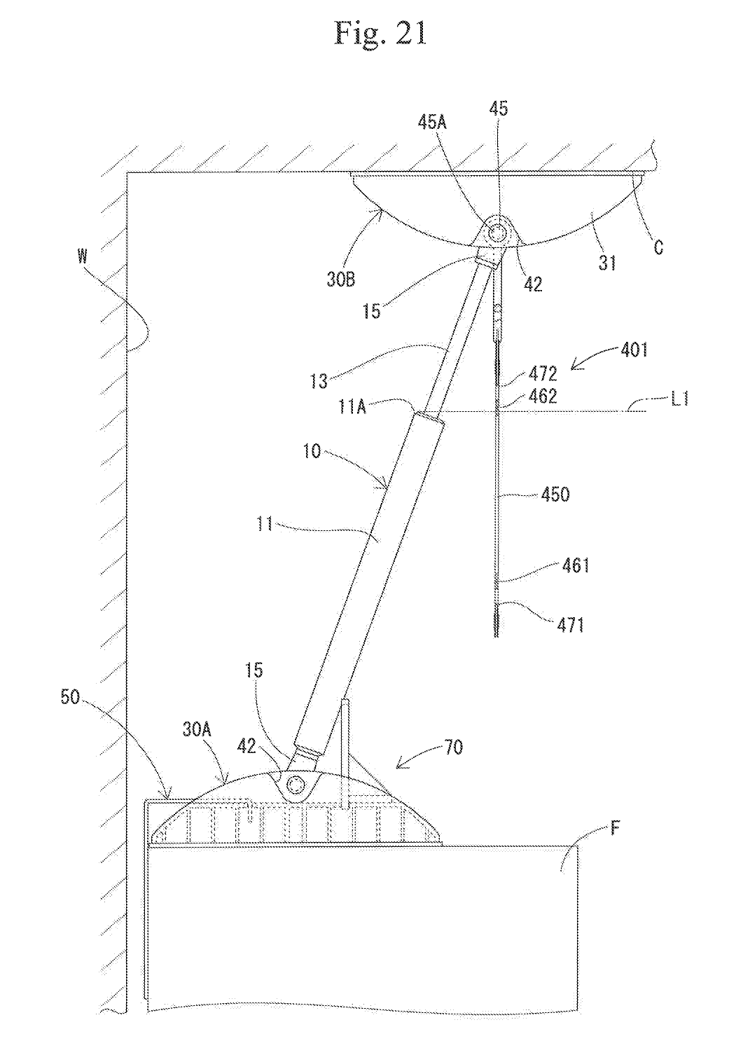

The overturn preventing device 401 as illustrated in FIG. 19 includes the damper 10 and the paired bases 30A and 30B all of which are similar to those in the first embodiment. The damper 10 is mounted between the top surface of the furniture F and the ceiling C in the mounting of the overturn preventing device 201, as illustrated in FIG. 21. The paired bases 30A and 30B are respectively coupled to both ends of the damper 10. The first base 30A abuts against the top surface of the furniture F, and the second base 30B abuts against the ceiling C in use of the overturn preventing device 401. The overturn preventing device 401 further includes the angle regulator 70 and the fall preventing part 50 each having the same structure and function as that in the first embodiment.

The fixing cord 490 as illustrated in FIG. 19 is made of a resin material or the like such as polypropylene. The fixing cord 490 has a first locking part 430 attached to the first base 30A, a second locking part 440 attached to the second base 30B, and a coupling part 450 coupling the first and second locking parts 430 and 440. The first locking part 430, the second locking part 440 and the coupling part 450 are integrated. The fixing cord 490 is horizontally symmetrical and has front and rear sides which are symmetrical or substantially symmetrical. In other words, the fixing cord 490 has the same shape when turned upside down, and the fixing cord 490 has the same or substantially the same shape when turned inside out.

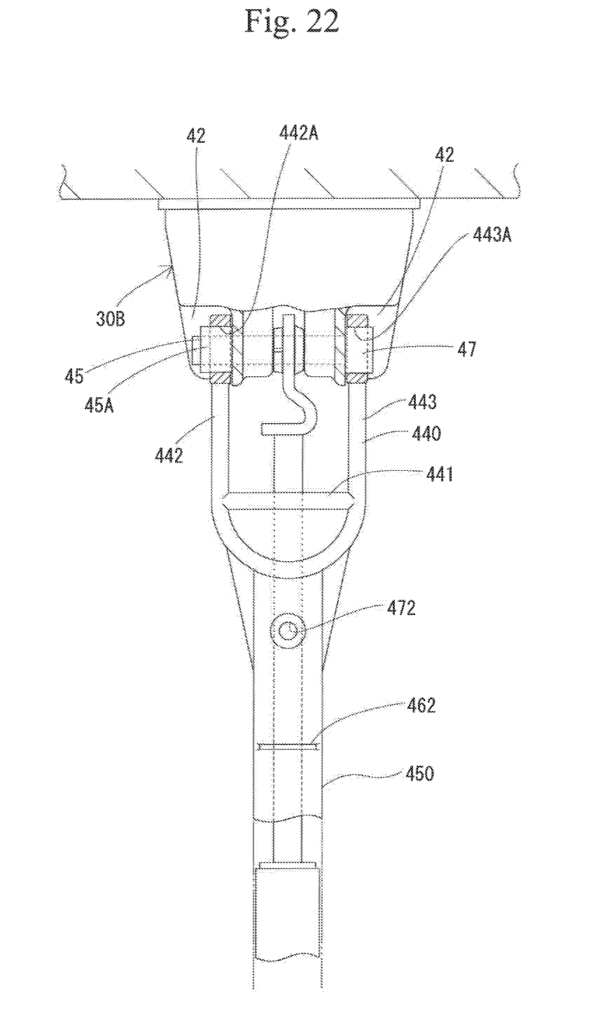

In the overturn preventing device 401, the bolt 45 and the nut (similar to the nut 47 in the first embodiment) mounted on the first base 30A function as the rotating shaft member at one side. The bolt 45 and the nut 47 mounted on the second base 30B function as the rotating shaft member at the other side as illustrated in FIG. 22.

The head 45A of the bolt 45 and the nut 47 serving as both ends of each rotating shaft member are respectively exposed in the recesses 42 of the base body 31 at positions symmetrical with respect to the central axis of the damper 10.

As illustrated in FIG. 22, the second locking part 440 is locked on the bolt 45 and the nut 47 mounted on the second base 30B, thereby being attached to the second base 30B abutting against the ceiling C. The second locking part 440 includes a root part 441 provided on an end of the coupling part 450 and extending laterally with respect to the longitudinal direction of the coupling part 450, and a pair of rising parts 442 and 443 rising from the root part 441, as illustrated in FIG. 20. The paired rising parts 442 and 443 are disposed to be opposed to each other and respectively have distal ends formed with through hole parts 442A and 443A facing each other. As illustrated in FIG. 22, the one through hole part 442A is fitted with the head 45A of the bolt 45 provided on the second base 30B thereby to be locked. The other through hole part 443A is fitted with the nut 47 thereby to be locked. The through hole parts 442A and 443A are examples of a fixing part.

As illustrated in FIG. 20, the first locking part 430 has the same shape as the second locking part 440. The first locking part 430 includes a root part 431 provided on an end of the coupling part 450 and extending laterally with respect to the longitudinal direction of the coupling part 450, and a pair of rising parts 432 and 433 rising from the root part 431. The paired rising parts 432 and 433 are disposed to be opposed to each other and respectively have distal ends formed with through hole parts 432A and 433A facing each other. The one through hole part 432A is fitted with the head 45A of the bolt 45 provided on the first base 30A thereby to be locked. The other through hole part 433A is fitted with the nut screwed on the bolt 45 thereby to be locked. Thus, the fixing cord 490 is attached so as to connect the first and second bases 30A and 30E.

As illustrated in FIG. 20, the coupling part 450 has a structure that connects the first and second locking parts 430 and 440 and is formed into the shape of a band having a predetermined thickness and a predetermined width. A first mark 461 is formed on one of side surfaces of the coupling part 450 at a location away from the through hole parts 442A and 443A (fixing parts). The first mark 461 is formed into, for example, a widthwise (lateral with respect to the longitudinal direction of the coupling part 450) groove formed in the one side surface of the coupling part 450. When the damper 10 has an allowable maximum length, the first mark 461 indicates a vertical location of an upper end 11A of the cylinder 11 in the state where a part of the fixing cord 490 from the through hole parts 442A and 443A to the first mark 461 droops from the second base 30B.

Furthermore, the coupling part 450 is formed with a second mark 462 at a location other than that of the first mark 461. The second mark 462 is formed into, for example, a widthwise (lateral with respect to the longitudinal direction of the coupling part 450) groove formed in the one side surface of the coupling part 450. When the damper 10 has an allowable minimum length, the second mark 462 indicates a location of the upper end 11A of the cylinder 11 in the state where a part of the fixing cord 490 from the through hole parts 442A and 443A to the second mark 462 droops from the second base 30B.

The allowable maximum length of the damper 10 can be set to a maximum length of the damper 10 in the case where an overall piston is filled with the hydraulic fluid or a length slightly shorter than the maximum length. In other words, a part of the piston 102 (FIG. 2 enters a region 109 of the compressed gas when the damper 10 extends over the maximum length. Furthermore, the allowable minimum length of the damper 10 can be set to a length that cannot allow a sufficient stroke of the piston 102, for example, a length that disallows further contraction of the damper 10 or a length slightly longer than the length that disallows further contraction of the damper 10.

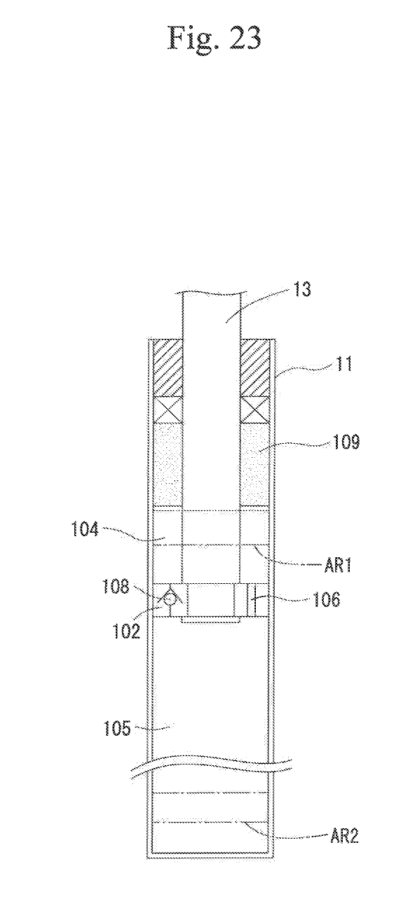

In this construction, an interior of the cylinder 11 has a structure as illustrated in FIG. 23, for example, and the cylinder 11 is filled with the hydraulic fluid and the compressed gas. The interior of the cylinder 11 is divided by the piston 102 into the rod side chamber 104 in which the proximal end of the rod 13 is housed and the counter-rod side pressure chamber 105. The piston 102 is formed with the orifice 106 which is a throttle valve communicating between both pressure chambers. The orifice 106 functions as a damping force generator which applies resistance to a flow of the hydraulic fluid between the rod side pressure chamber 104 and the counter-rod side pressure chamber 105 with the extending/contracting operation of the damper 10. Furthermore, the piston 102 is formed with the communication path communicating via the check valve 108 with both pressure chambers. The check valve 108 allows the hydraulic fluid to flow from the rod side pressure chamber 104 to the counter-rod side pressure chamber 105 and blocks reverse flow of the hydraulic fluid.

For example, assume that the length of the damper 10 in the case where the piston 102 is in a region AR1 in FIG. 23 is the allowable maximum length. When the damper 10 has such a length, the vertical location of the first mark 461 on the fixing cord 490 drooping from the second base 30B is the same as that of the upper end 11A of the cylinder 11. In other words, the first mark 461 is located on a straight line L1 as illustrated in FIG. 21.

For example, assume that the length of the damper 10 in the case where the piston 102 is in a region AR2 in FIG. 23 is the allowable minimum length. When the damper 10 has such a length, the vertical location of the second mark 462 on the fixing cord 490 drooping from the second base 30B is the same as that of the upper end 11A of the cylinder 11. In other words, the second mark 462 is located on the straight line L1 as illustrated in FIG. 21.

In the coupling part 450A, a hole part 471 is formed at a location near the first base 30A to penetrate therethrough in the thickness direction, and a hole part 472 is formed at a location near the second base 30B to penetrate therethrough in the thickness direction, as illustrated in FIGS. 19 and 20. The hole part 471 is formed at the location nearer the first locking part 430 than the first mark 461. The hole part 472 is formed at a location nearer the second locking part 440 than the second mark 462.

The damper 10 is contracted when the fixing cord 490 thus constructed is attached to the first and second bases 30A and 30B. In the contracted state of the damper 10, both locking parts 430 and 440 are respectively attached to both rotating shaft members (the bolts 45 and the nuts 47) of the first and second bases 30A and 30B. As a result, as illustrated in FIG. 19, connection is made between both rotating shaft members so that the extension of the damper 10 is disallowed, whereby the damper 10 is maintained in the contracted state.

The overturn preventing device 401 in this construction can be mounted in the same manner as that of the first embodiment. More specifically, after the overturn preventing device 401 set in the contracted state by the fixing cord 490 has been placed on the top surface of the furniture F as illustrated in FIG. 19, the coupling part 450 is cut at a predetermined position (for example, a position between the first mark 461 and the hole part 471). More specifically, the position of the first mark 461 formed to extend in the width direction should be determined as a cutting position, and the coupling part 450 should be cut along the first mark 461. Thereupon, the expansion force of the compressed gas filling the cylinder 11 extends the damper 10, so that the second base 30B abuts against the ceiling C as illustrated in FIG. 21. Thus, also in the overturn preventing device 401 in this construction, since the worker need not carry out the mounting work to contract the damper 10 above the furniture F, the overturn preventing device can be mounted between the top surface of the furniture F and the ceiling C easily and safely.

When the overturn preventing device 401 has been mounted between the ceiling C and the furniture F, as illustrated in FIG. 21, the coupling part 450 which is a part of the fixing cord 490 (FIG. 19) is hung from the second base 30B. In this case, it can be confirmed whether or not the damper 10 has an appropriate length by viewing the coupling part 450 drooping from the second base 30B.

More specifically, for example, an up-down relationship should be confirmed between the first mark 461 of the coupling part 450 drooping from the second base 30B and the upper end 11A of the cylinder 11 after both bases 30A and 30B have been mounted When the first mark 461 is located above the upper end 11A of the cylinder 11, it can be understood that the length of the damper 10 exceeds the predetermined maximum length. In an opposite manner, when the first mark 461 of the coupling part 450 drooping from the second base 30B is located below the upper end 11A of the damper 11, it can be confirmed that the length of the damper 10 is below the predetermined maximum length. When the coupling part 450 has been cut at the first mark 461, the lowest end of the cut coupling part 450 should be located below the upper end 11A of the cylinder 11. Thus, when the position of the first mark 461 is determined as the cutting position, the cutting position can clearly be presented to the worker carrying out the mounting work. And, in the mounted state after the cutting, it can be confirmed whether or not the length of the damper 10 is below the predetermined maximum length by confirming the positional relationship between the lower end of the fixing cord 490 drooping from the second base 30B abutting against the ceiling C and the upper end 11A (a predetermined part) of the cylinder 11. As a result, the confirming work becomes more accurate and easier.

Furthermore, when second mark 462 formed in the coupling part 450 drooping from the second base 30B abutting against the ceiling is located above the upper end 11A (the predetermined position) of the cylinder 11, it can be confirmed that the length of the damper 10 is not less than the predetermined minimum length. In an opposite manner, when the second mark 462 of the coupling part 450 drooping from the second base 30B is located below the upper end 11A (the predetermined position) of the cylinder 11, it can be understood that the length of the damper 10 does not reach the minimum length.

As described above, the fixing cord 490 of the overturn preventing device 401 in this construction includes the through hole parts 442A and 443A (fixing parts) mounted on the second base 30B abutting against the ceiling C, and the first mark 461 formed at the location away from the through hole parts 442A and 443A. When the damper 10 has the allowable maximum length, the first mark 461 indicates the location of the predetermined part of the damper 10 in the state where the part of the fixing cord 490 from the through hole parts 442A and 443A to the first mark 461 droops from the second base 30B abutting against the ceiling.

According to this construction, the positional relationship between the first mark 461 and the upper end 11A (the predetermined part) of the cylinder 11 can easily be confirmed after both bases 30A and 30B have respectively been mounted on the furniture F side and the ceiling C side by the release of the fixing cord 490. And, upon confirmation of the positional relationship, it can easily be confirmed whether or not the length of the damper 10 is below the predetermined maximum length.

Furthermore, the fixing cord 490 includes the second mark 462 formed at the position other than that of the first mark 461. When the damper 10 has an allowable minimum length, the second mark 462 indicates the position of the upper end 11A of the cylinder 11 in the state where the part of the fixing cord 490 from the through hole parts 442A and 443A to the second mark 462 droops from the second base 30B.

According to this construction, the positional relationship between the second mark 462 and the upper end 11A (the predetermined part) of the cylinder 11 can easily be confirmed after both bases 30A anal 30B have respectively been mounted on the furniture F side and the ceiling C side by the release of the fixing cord 490. Upon confirmation of the positional relationship, it can easily be confirmed whether or not the length of the damper 10 is not less than the predetermined minimum length.

Furthermore, the coupling part 450 is formed with the hole parts 471 and 472 which are respectively penetrating at the positions in the fixing code 490 near the first and second bases 30A and 30B. When the damper 10 needs to be held in the contracted state again after the damper 10 has been extended as illustrated in FIG. 21, the damper 10 can be maintained in the contracted state again by connecting both hole parts 471 and 472 using a wire, string or another connecting member.

Furthermore, the fixing cord 490 is horizontally symmetrical and has the front and rear sides which are symmetrical. In other words, the fixing cord 490 has the same shape even when reversed upside down and even when reversed inside out. As a result, the vertical direction and/or two sides of the fixing cord 490 need not be considered in the mounting of the fixing cord 490, with the result that an error of mounting the fixing cord 490 upside down and/or inside out can be reduced.

### Fifth Embodiment

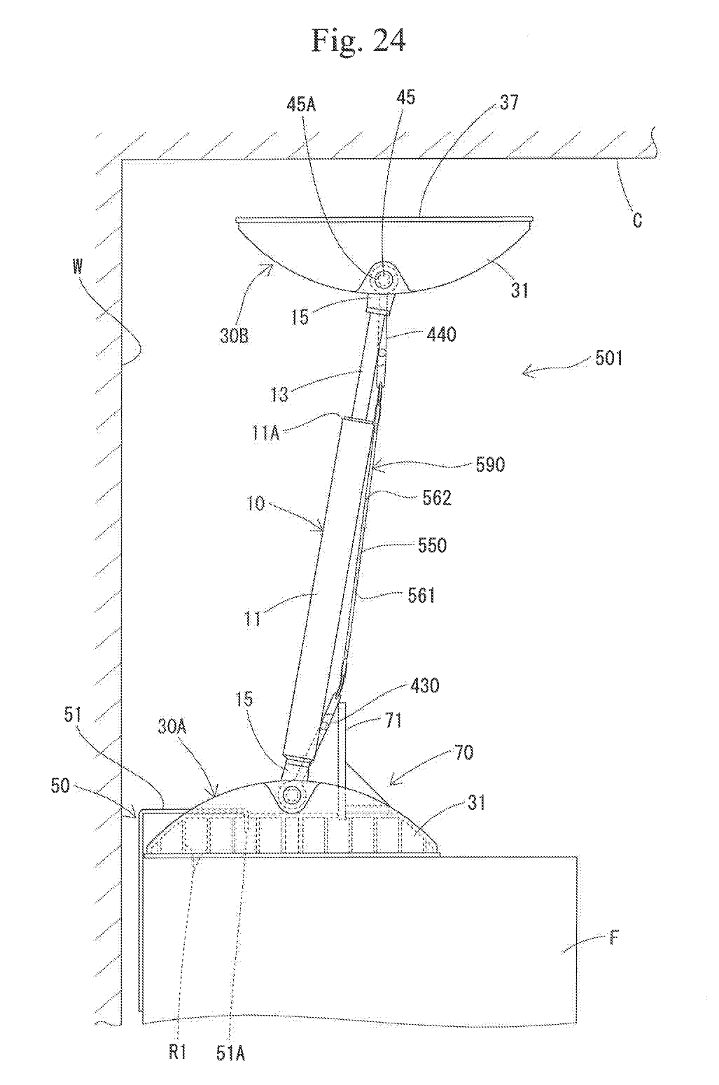

A fifth embodiment will be described with reference to FIGS. 24 to 26 and the like.

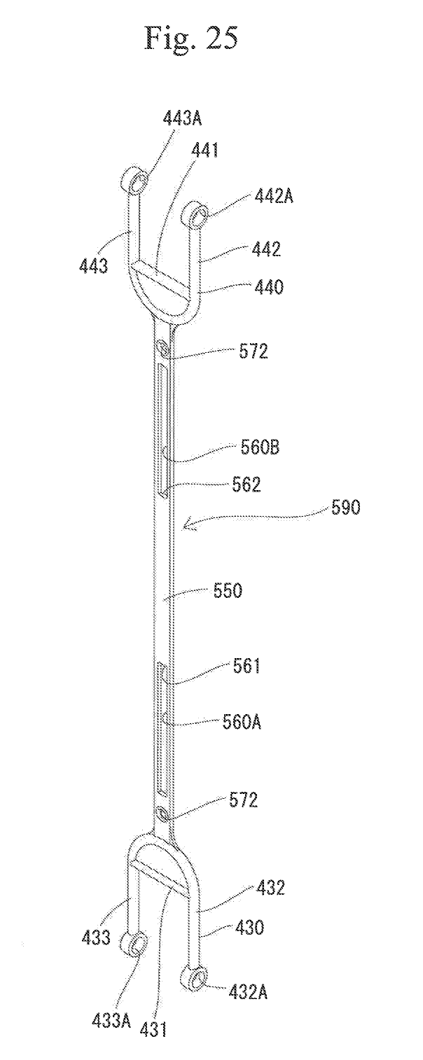

The overturn preventing device 501 of the fifth embodiment as illustrated in FIG. 24 and the like differs from that of the first embodiment in that the fixing cord 90 (FIG. 7 and the like) has been changed to a fixing cord 590 as illustrated in FIGS. 24 and 25. Other construction is same as that of the first embodiment in the other construction and has the same function. Accordingly, except for the fixing cord 590, identical or similar parts are labeled by the same reference symbols as those in the first embodiment, and the detailed description of these parts will be eliminated. Although the furniture F installed on the installation surface is also exemplified as the article in the following description, the overturn preventing device may also be applied to an article other than the furniture.

Furthermore, the fixing cord 590 differs only in the structure of the coupling part 550 from that of the fourth embodiment, and the first and second locking parts 430 and 440 other than the coupling part 550 have the same structures and the functions as those in the fourth embodiment. Accordingly, these identical parts are labeled by the same reference symbols as those in the fourth embodiment, and detailed description of the parts will be eliminated. The structure for attaching the first and second locking parts 430 and 440 to the respective first and second bases 30A and 30B is the same as that in the fourth embodiment.

In this construction, too, fixing cord 590 is attached so as to connect the first and second bases 30A and 30B, as illustrated in FIG. 24. The coupling part 550 of the fixing cord 590 has a structure that connects the first and second locking parts 430 and 440 and is formed into the shape of a band having a predetermined thickness and a predetermined width. A first mark 561 is formed in the coupling part 550 at a location away from the through hole parts 442A and 443A. The first mark 561 is formed, for example, as an upper end of an elongate hole part 560A formed in the coupling part 550. When the damper 10 has an allowable maximum length, the first mark 561 indicates a vertical location of the upper end 11A of the cylinder 11 in the state where a part of the fixing cord 590 from the through hole parts 442A and 443A (fixing parts) to the first mark 561 droops from the second base 30B.

Furthermore, the coupling part 550 is formed with a second mark 562 at a location other than that of the first mark 561. The second mark 562 is formed, for example, as a lower end of the elongate hole part 560B formed in the coupling part 550. When the damper 10 has an allowable minimum length, the second mark 562 indicates the position of the upper end 11A (the predetermined part) in the state where the part of the fixing cord 590 from the through hole parts 442A and 443A to the second mark 562 droops from the second base 30B abutting against the ceiling

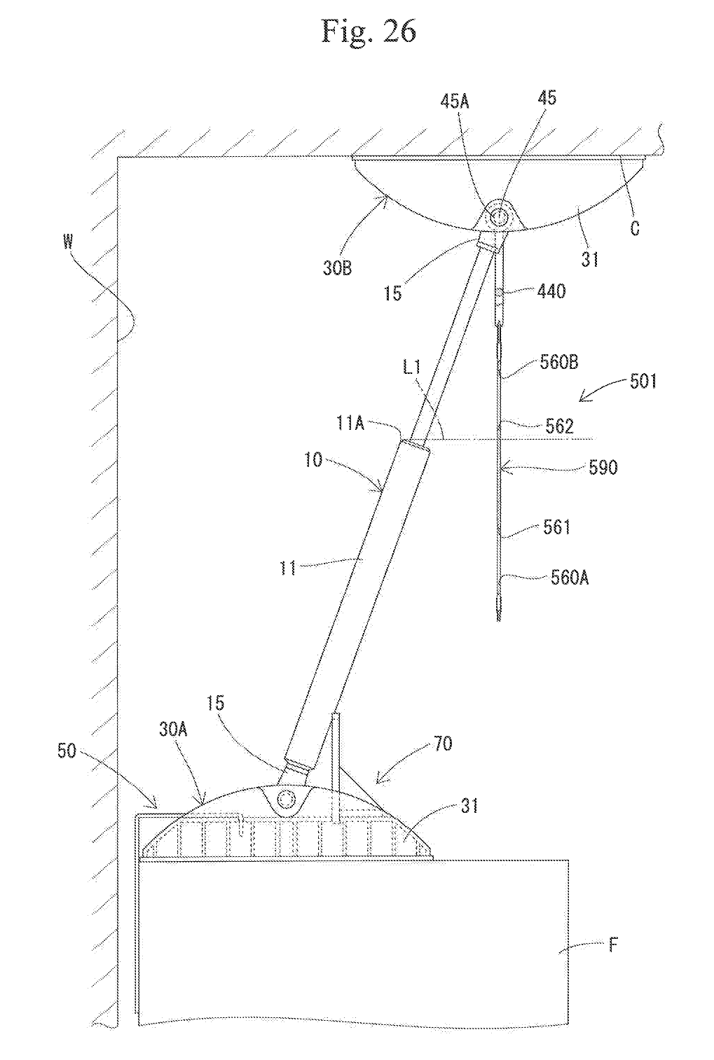

The overturn preventing device 501 as illustrated in FIG. 24 can also be mounted in the same manner as that of the first embodiment. More specifically, the overturn preventing device 501 can easily be mounted as illustrated in FIG. 26 by cutting the coupling part 550 at a predetermined position (for example, a position between the first mark 561 and the hole part 571) after the overturn preventing device 501 set in the contracted state by the fixing cord 590 as illustrated in FIG. 24 has been placed on the top surface of the furniture F. For example, the fixing cord 590 is easy to cut at the location of the elongate hole part 560A.

As illustrated in FIG. 26, when the overturn preventing device 501 has been mounted between the ceiling C and the furniture F, the coupling part 550 which is a part of the fixing cord 590 is hung from the second base 30B. In this case, it can be confirmed whether or not the damper 10 has an appropriate length by viewing the coupling part 550 drooping from the second base 30B. For example, when the first mark 561 formed in the coupling part 550 drooping from the second base 30B is located above the upper end 11A (the predetermined part) of the cylinder 11, it can be understood that the length of the damper 10 exceeds the predetermined, maximum length. In an opposite manner, when the first mark 561 of the drooping coupling part 550 is located below the upper end 11A of the cylinder 11, it can be confirmed that the length of the damper 10 is below the predetermined maximum length.

Furthermore, when the second mark 562 formed in the coupling part 550 drooping from the second base 30B is located above the upper end 11A (the predetermined part) of the cylinder 11, it can be confirmed that the length of the damper 10 is not less than the predetermined minimum length. In an opposite manner, when the second mark 562 of the drooping coupling part 550 is located below the upper end 11A (the predetermined part) of the cylinder 11, it can be understood that the length of the damper 10 does not reach the predetermined minimum length.

Furthermore, in this construction, too, the coupling part 550 is formed with the hole parts 571 and 572 which are respectively penetrating therethrough at the positions in the fixing code near the first and second bases 30A and 30B. When the damper 10 needs to be held in the contracted state again after the damper 10 has been extended as illustrated in FIG. 26, the damper 10 can be maintained in the contracted state again by connecting both hole parts 571 and 572 using a wire, string or another connecting member.

### Sixth Embodiment

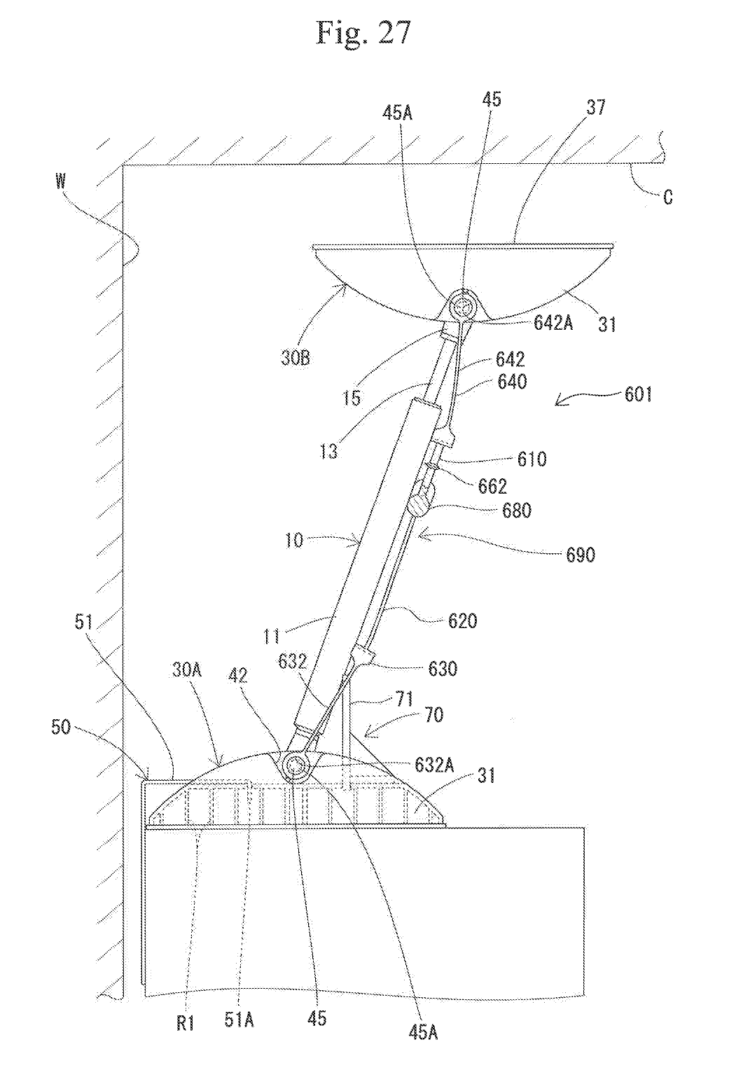

A sixth embodiment will be described with reference to FIGS. 27 to 30 and the like.

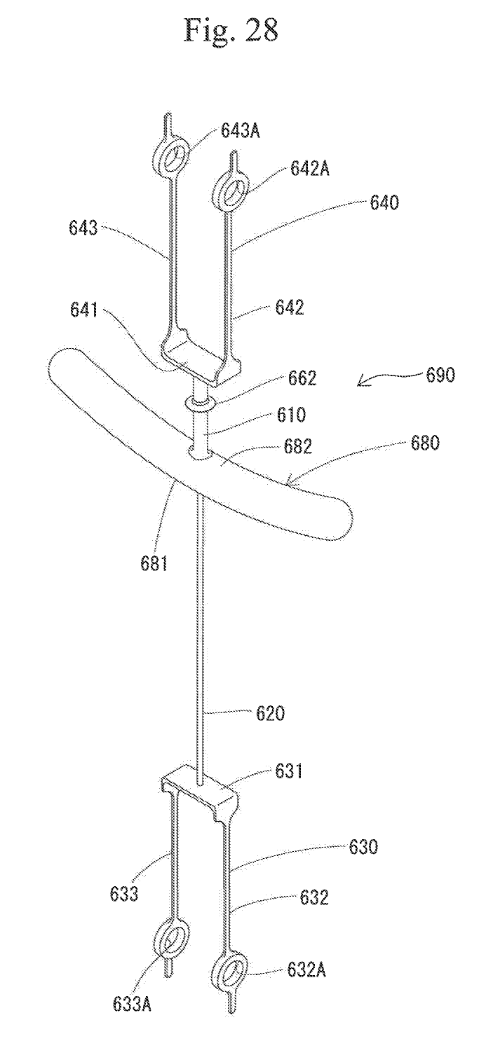

The overturn preventing device 601 of the sixth embodiment as illustrated in FIG. 24 and the like differs from that of the first embodiment in that the fixing cord 90 (FIG. 7 and the like) has been changed to a fixing cord 690 as illustrated in FIGS. 27 and 28. Other construction is same as that of the first embodiment in the other construction and has the same function. Accordingly, except for the fixing cord 690, identical or similar parts are labeled by the same reference symbols as those in the first embodiment, and the detailed description of these parts will be eliminated. Although the furniture F installed on the installation surface is also exemplified as the article in the following description, the overturn preventing device may also be applied to an article other than the furniture.

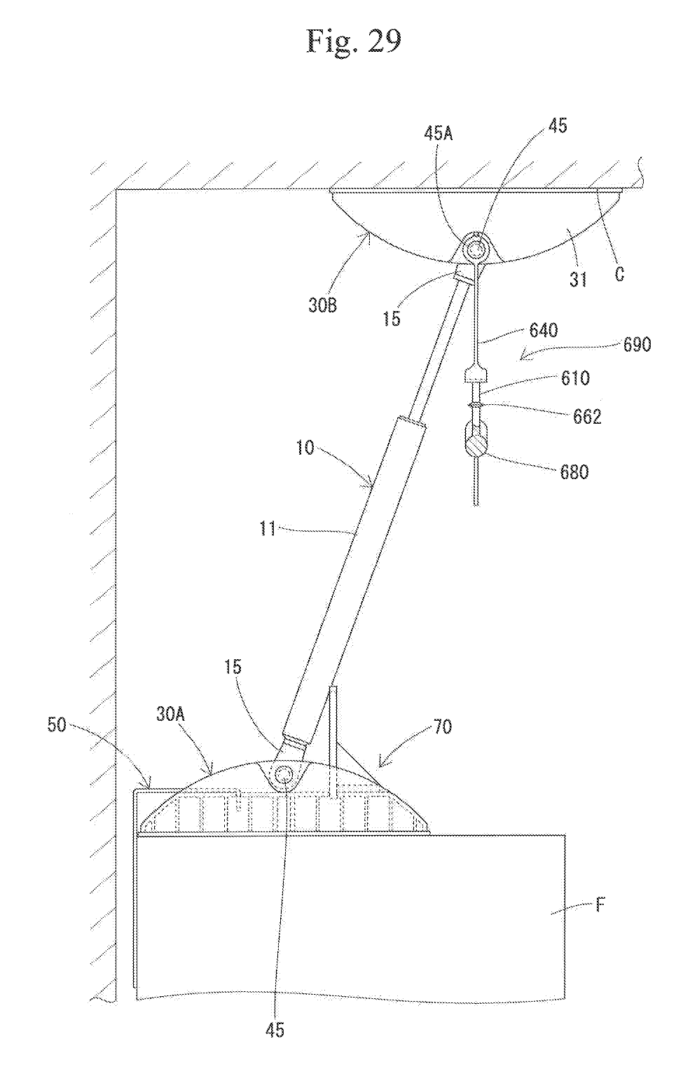

The overturn preventing device 601 as illustrated in FIG. 27 includes the damper 10 and the paired bases 30A and 30B all of which are similar to those in the first embodiment. The damper 10 is mounted between the top surface of the furniture F and the ceiling in the mounting of the overturn preventing device 601, as illustrated in FIG. 29. The paired bases 30A and 30B are respectively coupled to both ends of the damper 10. The first base 30A abuts against the top surface of the furniture F, and the second base 30E abuts against the ceiling C in use of the overturn preventing device 601. The overturn preventing device 601 further includes the angle regulator 70 and the fall preventing part 50 each having the same structure and function as that in the first embodiment.

The fixing cord 690 as illustrated in FIG. 28 is made of a resin material or the like such as polypropylene and has the first locking part 630 attached to the first base 30A, the second locking part 640 attached to the second base 30B, and a curved bar-shaped grip 680. The fixing cord 690 further includes the article-side coupling part 620 coupling the first locking part 630 and the grip 680 and the ceiling-side coupling part 610 coupling the second locking part 640 and the grip 680. The first locking part 630, the second locking part 640, the grip 680, the article-side coupling part 620, and the ceiling-side coupling part 610 are integrated.

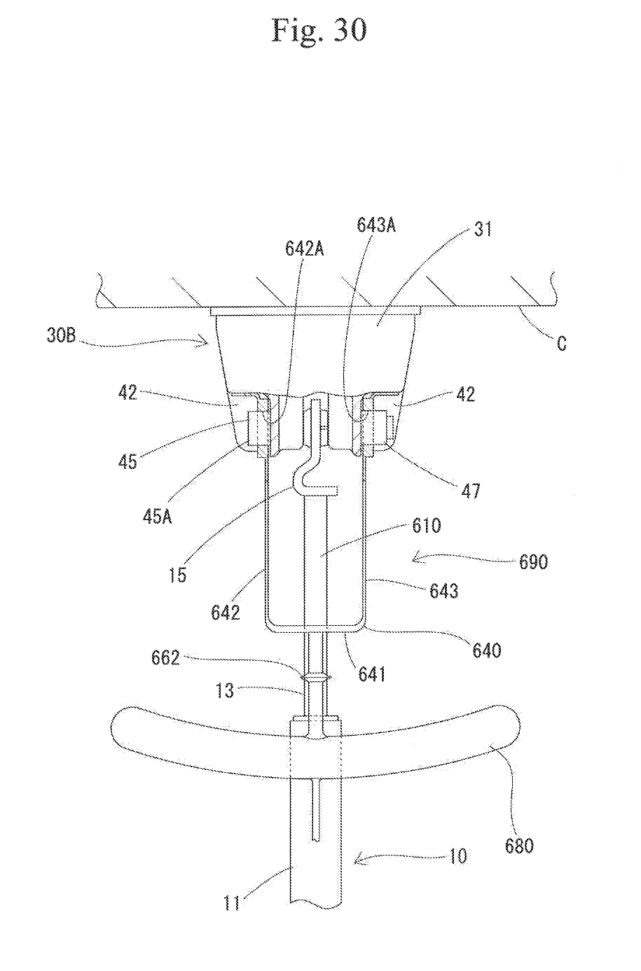

In the overturn preventing device 601, the bolt 45 and the nut (similar to the nut 47 in the first embodiment) screwed on the bolt 45 both of which are mounted on the first base 30A function as the rotating shaft member at one side. The bolt 45 and the nut 47 both of which are mounted on the second base 308 as illustrated in FIG. 30 function as the rotating shaft member at the other side. The head 45A of the bolt 45 and the nut 47 serving as both ends of each rotating shaft member are respectively exposed in the recesses 42 of the base body 31 at positions symmetrical with respect to the central axis of the damper 10. The first locking part 630 provided at one end side of the fixing cord 690 is locked on the bolt 45 and the nut 47 mounted on the first base 30A. The second locking part 640 provided at the other end side of the fixing cord 690 is locked on the bolt 45 and the nut 47 mounted on the second base 308, as illustrated in FIG. 30. Thus, the fixing cord 690 is attached so as to connect the first and second bases 30A and 308.

The second locking part 640 includes a root part 641 arranged transversely to the ceiling-side coupling part 610 and a pair of rising parts 642 and 643 rising from the root part 641, as illustrated in FIG. 28. The paired rising parts 642 and 643 are arranged to be opposed to each other. The rising parts 642 and 643 are respectively formed with through hole parts 642A and 643A facing each other. The one through hole part 642A is fitted with the head 45A of the bolt 45 provided on the second base 308 thereby to be locked, as illustrated in FIG. 30. The other through hole part 643A is fitted with the nut 47 thereby to be locked. The through hole parts 642A and 643A exemplify the fixing part.

The ceiling-side coupling part 610 is coupled to a longitudinally central part of the root part 641 and extends from the side opposed to the surface side where the rising parts 642 and 643 protrude. A central part of the grip 680 is coupled to one end of the ceiling-side coupling part 610. The ceiling-side coupling part 610 is coupled via the second locking part 640 to the second base 30B abutting against the ceiling C thereby functioning so as to couple the second base 30B and the grip 680.

The grip 680 is coupled to the second base 30B via the second locking part 640 and the ceiling-side coupling part 610 and is hung as illustrated in FIG. 29 in the mounted state of the overturn preventing device 601. The grip 680 is configured to be indicative of a predetermined direction representing the location side of the first base 30A abutting against the article. The grip 680 is formed into the shape of an arcuately curved bar and includes a concave side part concave part 682) to which the ceiling-side coupling part 610 is coupled, as illustrated in FIGS. 28 and 30. The article-side coupling part 620 is coupled to a convex side part (a convex part 681) of the grip 680. The grip 680 indicates the location side of the first base 30A by a direction of the curved convex part 681. The grip 680 indicates the location side of the second base 30B by the side to which the curved concave part 682 is directed (the side the concave part 682 faces).

In this construction, when either first locking part 630 or second locking part 640 is held and hung, the location side of the first base 30A is indicated by the direction of the convex part 681 of the grip 680. For example, when the second locking part 640 is held and hung, the convex part 681 is downwardly convex. Accordingly, it can be understood that the lower side is the location side of the first base 30A. Furthermore, when the first locking part 630 is held and hung, the convex part 681 is upwardly convex. Accordingly, it can be understood that the upper side is the location side of the first base 30A.

The article-side coupling part 620 has a function of coupling the first base 30A abutting against the top surface of the furniture F and the grip 680, and is a part to be cut in the mounting work. In this construction, the ceiling-side coupling part 610 is thicker than the article-side coupling part 620. The ceiling-side and article-side coupling parts 610 and 620 have respective circular cross sections, and the ceiling-side coupling part 610 has a larger outer diameter than the article-side coupling part 620.

The first locking part 630 includes a root part 631 arranged transversely to the article-side coupling part 620 and a pair of drooping parts 632 and 633 drooping from the root part 631. A central part of the root part 631 is coupled to an end of the article-side coupling part 620. The paired drooping parts 632 and 633 are disposed to be opposed to each other. The drooping parts 632 and 633 extend substantially in parallel to each other and are respectively formed with through hole parts 632A and 633A located near distal ends thereof and facing each other. The one through hole part 632A is fitted with the head 45A of the bolt 45 provided on the first base 30A thereby to be locked. The other through hole part 633A is fitted with the nut screwed on the bolt 45 thereby to be locked.

The damper 10 is contracted when the fixing cord 690 is to be attached to the first and second bases 30A and 30B. In the contracted state of the damper 10, both locking parts 630 and 640 are respectively attached t both rotating shaft members (the bolts 45 and the nuts 47) of the first and second bases 30A and 30B. As a result, as illustrated in FIG. 27, connection is made between both rotating shaft members so that the extension of the damper 10 is disallowed, whereby the damper 10 maintained in the contracted state. The overturn preventing device 601 can be set into the above-described contracted state and an be mounted in the same manner as that of the first embodiment. As illustrated in FIG. 29, when the overturn preventing device 601 has been mounted between the ceiling C and the furniture F, the grip 680 which is a part of the fixing cord 690 is hung via article-side coupling part 610 from the second base 30B. In such a mounted state, the mounting work can be finished if the second base 30B abuts against the ceiling C at a desired position. If the second base 30B is not in contact with the ceiling C at a desired position in the mounted state and needs to be relocated, the same moving operation as that in the second and third embodiments should be carried out with the grip 680 being grasped.

In this construction, the second mark 662 is formed in the ceiling-side coupling part 610 at the location away from the through hole parts 642A and 643A (fixing parts). The second mark 662 is formed as a flange protruding outward in the ceiling-side coupling part 610 formed in a shaft shape. When the damper 10 has an allowable minimum length, the second mark 662 indicates a location of the upper end 11A of the cylinder 11 in the state where the part of the fixing cord 690 from the through hole parts 642A and 643A (fixing parts) to the second mark 662 droops from the second base 30B abutting against the ceiling C. With this construction, it can be confirmed whether or not the damper 10 has a length not less than the allowable minimum length by the use of the second mark 662 in the same manner as in the fourth and fifth embodiments.

The first mark which is the same as those in the fourth and fifth embodiments may be formed in the fixing cord 690. The first mark may be flanged in the same manner as the second mark 662 or may be formed into another shape such as a protrusion, a groove or a mark of a predetermined color. The first mark should indicate a vertical location of the upper end 11A of the cylinder 11 when the damper 10 has an allowable maximum length, in the state where the part of the fixing cord 690 from the through hole parts 642A and 643A to the first mark droops from the second base 30B abutting against the ceiling C. In this construction, it can be confirmed whether or not the damper 10 has a length below an allowable maximum length by the use of the first mark in the same manner as in the fourth and fifth embodiments.

### Seventh Embodiment

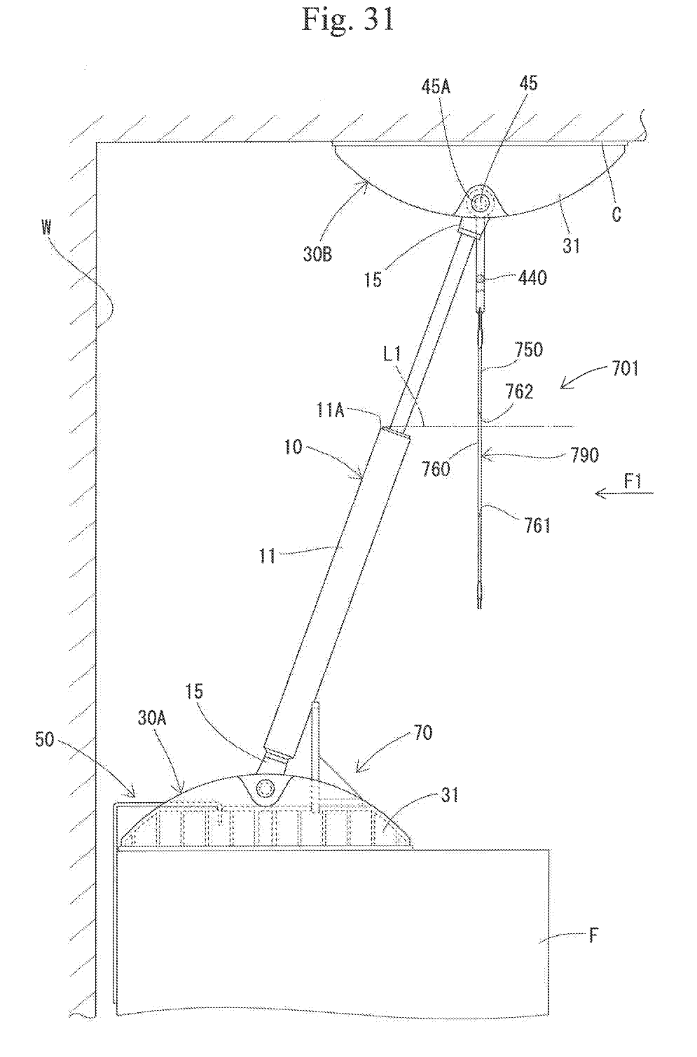

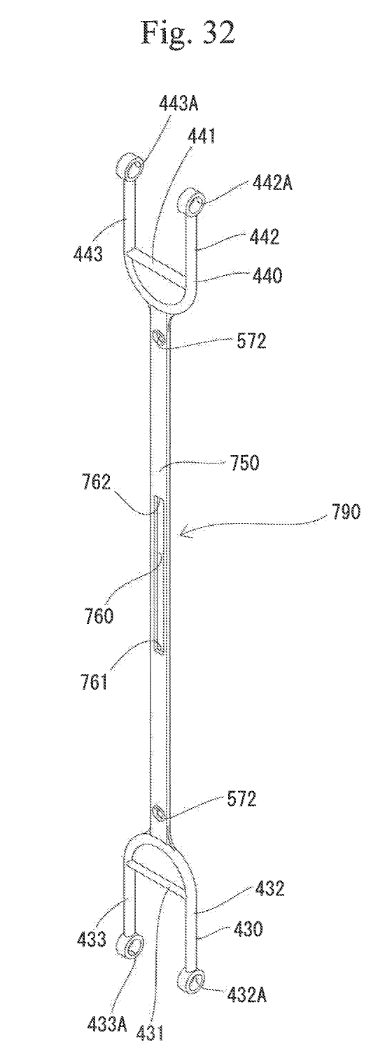

A seventh embodiment will be described with reference to FIGS. 31, 32 and the like.

The overturn preventing device 701 of the seventh embodiment as illustrated in FIGS. 31 and 32 differs from that of the first embodiment in that the fixing cord 90 (FIG. 7 and the like) has been changed to a fixing cord 790 as illustrated in FIGS. 31 and 32. Other construction is same as that of the first embodiment in the other construction and has the same function. Accordingly, except for the fixing cord 790, identical or similar parts are labeled by the same reference symbols as those in the first embodiment, and the detailed description of these parts will be eliminated. Although the furniture F installed on the installation surface is also exemplified as the article in the following description, the overturn preventing device may also be applied to an article other than the furniture.

Regarding the fixing cord 790, only the structure of the coupling part 750 differs from those in the fourth and fifth embodiments, and the first and second locking parts 430 and 440 other than the coupling part 750 have the same structures and the functions as those in the fourth and fifth embodiments. The structure to attach the first and second locking parts 430 and 440 to the respective first and second bases 30A and 30B is the same as those in the fourth and fifth embodiments. Accordingly, these parts are labeled by the same reference symbols as those in the fourth and fifth embodiments, and detailed description of the parts are eliminated. The coupling part 750 differs from the coupling part 550 in the fifth embodiment only in an elongate hole part 760 formed instead of the elongate hole parts 560A and 560B (FIGS. 25 and 26). The coupling part 750 is the same as the coupling part 550 in the fifth embodiment in the other respects. In this construction, a lower end of the elongate hole part 760 is the first mark 761, and an upper end of the elongate hole part 760 is the second mark 762.

The overturn preventing device 701 as illustrated in FIG. 31 can also be set into the contracted state (the same contracted state as that in FIG. 24) in which the fixing cord 790 as illustrated in FIG. 32 is attached to the first and second bases 30A and 30B, and can be mounted in the same manner as that of the first embodiment. More specifically, the overturn preventing device 701 can easily be mounted as illustrated in FIG. 31 by cutting the coupling part 750 at a predetermined position (for example, the position below the elongate hole part 760) after the overturn preventing device 701 set in the contracted state by the fixing cord 790 has been placed on the top surface of the furniture F.

As illustrated in FIG. 31, when the overturn preventing device 701 has been mounted between the ceiling C and the furniture F, the coupling part 750 which is a part of the fixing cord 790 is hung from the second base 30B. In this case, it can be confirmed whether or not the damper 10 has an appropriate length by viewing the coupling part 750 drooping from the second base 30B. For example, when the first mark 761 formed in the coupling part 750 drooping from the second base 30B is located above the upper end 11A (the predetermined part) of the cylinder 11, it can be understood that the length of the damper 10 exceeds the predetermined maximum length. In an opposite manner, when the first mark 761 of the drooping coupling part 750 is located below the upper end 11A of the cylinder 11, it can be confirmed that the length of the damper 10 is below the predetermined maximum length. Furthermore, when the second mark 762 formed in the coupling part 750 drooping from the second base 30B is located above the upper end 11A of the cylinder 11, it can be confirmed that the length of the damper 10 is not less than the predetermined minimum length. In particular, the location of the upper end 11A of the cylinder 11 can be confirmed through the inside of the elongate hole part 760 by viewing the fixing cord 790 from the front side as illustrated by arrow F1. For example, when the worker views the elongate hole part 760 in the horizontal direction and the upper end 11A of the cylinder 11 in the elongate hole part 760 can be seen, it can be confirmed that the overturn preventing device 701 is appropriately mounted.

The present invention should not be limited to the embodiments described above with reference to the drawings, but the technical scope of the invention encompasses the following embodiments, for example.
(1) Although the overturn preventing device is mounted on the furniture in each of the first to seventh embodiments, the overturn preventing device may be mounted on an article such as a bookshelf or a refrigerator which has a possibility of overturn by shaking of earthquake or the like.
(2) Although the overturn preventing device is mounted on the furniture installed on the floor with its rear surface being opposed to the wall surface in each of the first to seventh embodiments, the overturn preventing device may be mounted on the furniture or the like installed on the floor without being adjacent to the wall surface.
(3) The fixing cord is the string made of the chemical fiber in the first embodiment. Furthermore, in the second embodiment, the fixing cord is a combination of the resin member and the string, and the fixing cord is the string in the third to six embodiments. However, the fixing cord should not be limited to these materials, and the fixing cord may be made of a metal or another material as long as the fixing cord is loosened or cut.
(4) In each of the first to seventh embodiments, both ends of the damper are respectively coupled to the bases so as to be rotatable about the rotation axes and swingable in the direction intersecting the rotation direction. However, both ends of the damper may not be respectively coupled to the bases so as to be rotatable or swingable.
(5) In each of the first to seventh embodiments, the fixing cord is locked on the heads of the bolts and the nuts forming the respective rotating shaft members thereby to hold the damper in the contracted state. However, the fixing cord may directly be locked on the bases, or the bases and the damper may be provided with respective parts on which the fixing cord is locked so that the damper is held in the contracted state.
(6) Although the compression damper is used in each of the first to seventh embodiments, a two-way damper may be used as long as it can exert a predetermined damping force in a contracting operation.
(7) Although the damper including a cylinder filled with a hydraulic fluid and a compressed gas is used in each of the first to seventh embodiments, a fluid-pressure damper using a cylinder filled with another fluid or another type of damper may be used as long as it can exert a predetermined damping force in a contracting operation.
(8) In each of the first to seventh embodiments, the cylinder is filled with the compressed gas so that an expansion force of the compressed gas acts in an extension direction. However, a force acting in the extension direction may be generated by another manner.
(9) Although the overturn preventing device includes the fall preventing part in each of the first to seventh embodiments, the overturn preventing device may not include the fall preventing part. Furthermore, the fall preventing part may be formed integrally with the first base.
(10) Although the overturn preventing device includes the angle regulator in each of the first to seventh embodiments, the overturn preventing device may not include the angle regulator. Furthermore, although the angle regulator is detachably attached to the first base in the first embodiment, the angle regulator may be formed integrally with the first base or the cylinder of the damper.
(11) Although the shape of the entire grip is indicative of the direction in each of the third and sixth embodiments, the shape of a part of the grip may be indicative of the direction. For example, the grip 680 in the sixth embodiment may be changed into the shape of a bar in which a part of the grip is curved to one base side.
(12) Each of the second to seventh embodiments exemplifies the fixing cord a part or an entire of which is made of a resin material such as polypropylene. The resin material should not be limited to polypropylene but various known materials may be used. In this case, each of the materials preferably should have stretchability suppressed to some extent.
(13) The first mark, the second mark or both marks may be provided in the construction of each of the first to third embodiments. When these are provided in the construction of the third embodiment, the fixing cord may be formed with a groove or the like which represents the first mark and the second mark. The straight part 386 of the lower end of the grip may be the first mark, and the corner 381 of the upper end of the grip may be the second mark. In this case, the straight part 386 should be located so that the position thereof serves as that of the first mark, and the corner 381 should be located so that the position thereof serves as that of the second mark.
(14) Although each of the fourth to seventh embodiments exemplifies the groove, the hole, the protrusion or the like as the first mark and the second mark, the first and second marks just needs to be the marks differing from other parts. For example, the first and second marks may be colored or patterned so as to differ from the circumference.

### EXPLANATION OF REFERENCE SYMBOLS

C . . . ceiling; F . . . furniture (article); 10 . . . damper; 11A . . . upper end (predetermined position of the damper); 30A, 30B, . . . bases (30A . . . first base, 30B . . . second base); 45, 47 . . . rotating shaft member (45 . . . bolt, 47 . . . nut); 45A, 47 . . . both ends of the rotating shaft member (45A . . . head of the bolt, 47 . . . nut); 90, 290, 390, 490, 590, 690, 790 . . . fixing cord.; 220, 320, 620 . . . article-side coupling part; 280, 380, 680 . . . grip; 310, 610 . . . ceiling-side coupling part; 442A, 443A, 642A, 643A . . . through hole part (fixing part); 461, 561, 761 . . . first mark; 462, 562, 762 . . . second mark; and 471, 472, 571, 572 . . . hole part.

1. An overturn preventing device comprising:
a damper to be mounted between a top surface of an article installed on an installation surface and a ceiling;
a pair of bases respectively coupled to both ends of the damper, one of the bases being configured to abut against the top surface of the article, the other base being configured to abut against the ceiling; and
a fixing cord holding the damper in a contracted state in which the damper has a desired length.

2. The overturn preventing device according to claim 1, wherein the bases respectively have rotating shaft members rotatably supporting both ends of the damper, and the fixing cord is locked on the rotating shaft members.

3. The overturn preventing device according to claim 2, wherein each of the rotating shaft members has two ends exposed from the base at respective positions symmetrical with respect to a central axis of the damper, and the fixing cord includes two sides which are respectively locked on both ends of the rotating shaft members exposed from the bases and a middle part extending as a single cord.

4. The overturn preventing device according to claim 1, further comprising an angle regulator mounted on the base abutting against the top surface of the article to regulate an inclination angle of the damper.

5. The overturn preventing device according to claim 1, wherein the fixing cord includes a grip coupled to the base abutting against the ceiling, and an article-side coupling part coupling the base abutting against the top surface of the article and the grip.

6. The overturn preventing device according to claim 5, wherein the grip includes at least a part thereof formed into a shape indicative of a predetermined direction representing a location side of the base abutting against the ceiling or the base abutting against the top surface of the article.

7. The overturn preventing device according to claim 5, wherein the fixing cord further includes a ceiling-side coupling part coupling the base abutting against the ceiling and the grip, and the ceiling-side coupling part is thicker than the article-side coupling part.

8. The overturn preventing device according to claim 1, wherein the fixing cord includes a fixed part attached to the base abutting against the ceiling and a first mark formed at a position away from the fixed part, and the first mark is indicative of a location of a predetermined part of the damper when the damper has a predetermined maximum length in a state where a part of the fixing cord at least from the fixing part to the first mark droops from the base abutting against the ceiling.

9. The overturn preventing device according to claim 8, wherein the fixing cord further includes a second mark formed at a location other than that of the first mark, and the second mark is indicative of a location of the predetermined part of the damper when the damper has a predetermined minimum length in a state where a part of the fixing cord at least from the fixing part to the second mark droops from the base abutting against the ceiling.

10. The overturn preventing device according to claim 8, wherein the location of the first mark is a cutting location.

11. The overturn preventing device according to claim 1, wherein the fixing cord has through hole parts respectively formed at a location near one of the bases and at a location near the other base.
